(19) United States
(12) Patent Application Publication
(10) Pub. No.: US 2025/0302046 A1
(43) Pub. Date: Oct. 2, 2025

(54) BROAD SPECTRUM DISINFECTING COMPOSITIONS

(71) Applicant: ADVANCED PEROXIDE TECHNOLOGIES (APT) B.V., Hilversum (NL)

(72) Inventor: Ilja BOBBERT, Hilversum (NL)

(73) Assignee: ADVANCED PEROXIDE TECHNOLOGIES (APT) B.V., Hilversum (NL)

(21) Appl. No.: 19/089,536

(22) Filed: Mar. 25, 2025

(30) Foreign Application Priority Data
Mar. 26, 2024 (EP) 24166296.4

(51) Int. Cl. A01N 59/00; A01N 25/02; A01N 25/30; A01N 25/34; A01N 37/02; A01P 1/00

(52) U.S. Cl. CPC A01N 59/00; A01N 25/02; A01N 25/30; A01N 25/34; A01N 37/02; A01P 1/00

(57) ABSTRACT

A disinfecting composition includes: one or more acetate-containing solvents in a total amount of from 0.1 to 20 wt. %; from 0.1 to 15 wt. % of hydrogen peroxide; and one or more biocidally active compounds in a total amount of from 0.1 to 10 wt. %; and wherein the disinfecting composition has a pH of from 0.5 to 3.5. The disinfecting composition was shown to have broad antimicrobial activity, including against bacteria and viruses, as well as to have excellent material compatibility.

### FIELD OF THE INVENTION

The disclosure relates to disinfecting compositions, in particular disinfecting compositions suitable for use in broad-spectrum disinfection of a surface, particularly using preimpregnated towelettes. The disclosure also relates to methods and uses in which the disinfecting compositions are used.

### BACKGROUND AND SUMMARY

Disinfecting compositions can be applied to a surface in a number of ways. For example, disinfecting compositions can be applied to a surface using a trigger sprayer, continuous sprayer, trigger foamer or with towelettes impregnated with the disinfecting composition. The use of towelettes for application of a disinfecting composition is especially desirable, as it is very convenient.

Disinfecting a surface with a disinfecting composition that has a broad spectrum efficacy is critically important because it is often unknown with which organisms a hard surface is contaminated. For instance, Candida auris and several small non-enveloped viruses are very hard-to-kill organisms, and pose a major threat to human health.

Furthermore, a short and practically realistic contact time is critically important to ensure compliance in daily disinfection routines. A contact time of at most 2 minutes is often desired, but (even) shorter contact time are preferred. However, only a few disinfecting compositions described in the literature are actually suitable for use in towelettes, have a broad spectrum antimicrobial efficacy and require a short contact time to disinfect a surface.

Another important aspect of a disinfectant composition is its effect on materials like plastics, metals, rubbers or glue. Many objects in healthcare environments are made of plastic or metal surfaces with rubber seals. It is important to effectively disinfect these objects or surfaces without causing damage to the object. Material compatibility with a wide spectrum of materials often used in healthcare settings is therefore also an important feature of a disinfectant.

WO 2020/152245 describes a water-based virucidal composition suitable for disinfecting a surface contaminated with non-enveloped viruses. The examples of WO 2020/152245 demonstrate the virucidal compositions can be applied using towelettes. Particularly, it is shown that the virucidal compositions are active against Feline Calicivirus when applied to a surface contaminated with Feline Calicivirus for at least two minutes. This contact time is relatively long. Moreover, it has been found that compositions disclosed in WO 2020/152245 have relatively poor material compatibility with, e.g., rubbers.

WO 2008/071746 describes a composition for skin disinfection. It is said the composition can be in the form of an impregnated towelette. However, the compositions according to WO 746 are shown to be only active against Staphylococcus aureus, Salmonella thyphimurium, and Escherichia coli in suspension tests after three to five minutes. This is a narrow spectrum efficacy with relatively long contact times.

WO 2007/080187 describes a biocidal composition. The biocidal composition is shown to be active against bacteria and viruses in suspension tests after one to ten minutes. It is not said the composition can be applied using a towelette. One to ten minutes is a relatively long contact time in a suspension test and often not practically useful.

WO 2007/125101 describes a composition that can be used as a disinfecting composition. The composition is shown to be active in bacterial suspension tests after one to five minutes. It is not said the composition can be applied using a towelette. One to five minutes for efficacy against only bacteria is a relatively long contact time in a suspension test and such narrow spectrum is often not practically useful.

The antimicrobial activity observed in suspension tests is generally higher than the antimicrobial activity observed in tests using towelettes (also known as “wet wipes”). Indeed, as shown in Example 5 herein, compositions according to, e.g., WO 2008/071746 and WO 2007/080187 were found to be ineffective against S. aureus when applied using a towelette. Accordingly, when disinfecting compositions described in the literature discussed above are or would be applied using towelettes, longer contact times are or would be required. This is undesirable, as long contact times lead to misuse of the disinfecting composition, which, in turn, leads to insufficient disinfection and non-compliance.

Also, efficacy against only ‘easier-to-kill’ basic bacteria does not mean sufficient efficacy against harder-to-kill and clinically more relevant organisms, such as Candida auris or non-enveloped viruses.

There is a need in the art for improved disinfection compositions. Particularly, there is a need in the art for safe and effective disinfecting compositions that can successfully be applied to surfaces using towelettes, without requiring long contact times, with a broad spectrum of antimicrobial efficacy, and without negatively affecting the surfaces in healthcare settings. The present disclosure provides such disinfecting compositions.

The disinfecting compositions disclosed herein are capable of passing the United States' Environmental Protection Agency's tests for towelettes (Germicidal Towelette Method/AOAC Official Method 961.02 and ASTM E1053-20 as amended for towelettes). This test is very hard to pass, but is required to achieve a pesticide registration. Consequently, the disinfecting compositions disclosed herein meet the Environmental Protection Agency's requirements for pesticide registration.

Additionally, the disinfecting compositions disclosed herein are surprisingly compatible with a wide variety of surfaces. Material compatibility with a number of frequently used plastics, rubbers, metals and with stainless steel has been demonstrated. Moreover, the disinfecting compositions disclosed herein have a good odor, in contrast to certain composition described in the art. Even more, the disinfecting composition disclosed herein is surprisingly stable over long periods of time.

### BRIEF DESCRIPTION OF THE DRAWINGS

FIG. 1 shows the effects of sample 3 and comparative sample 24 on a strip of polyurethane.

FIGS. 2A and 2B show the effects of sample 3 and comparative sample 24 on a strip of PPMA.

### DETAILED DESCRIPTION

The present disclosure relates to a disinfecting composition comprising:
a) one or more compounds according to formula I:

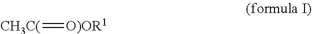

wherein R¹ is
   C(1-5)alkoxy-C(1-5)alkyl wherein the C(1-5)alkoxy is optionally substituted with one hydroxyl group or methyl ester,
   C(1-3)alkoxy-C(1-5)alkoxy-C(1-5)alkyl wherein the C(1-3)alkoxy is optionally substituted with one hydroxyl group or methyl ester,
   C(2-5)alkyl wherein the C(2-5)alkyl is substituted with one or two methyl esters and/or one or two hydroxyl groups,
   C(2-12)alkyl, in particular C(2-5)alkyl,
   C(2-12)alkenyl, in particular C(3-7)alkenyl,
   C(2-12)alkynyl, in particular C(3-7)alkynyl, or
   C(6)aryl-C(1-2)alkyl optionally substituted with one or more hydroxy, methoxy, amino, or C(1-3)alkyl groups,
and/or one or more compounds according to formula Ia:

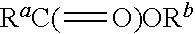

wherein R^{a} is C(6)aryl optionally substituted with hydroxyl, and R^{b} is a C(1-6)alkyl or C(6)aryl-(C1-2)alkyl,
wherein R^{a} is C(6)aryl-C(1-2)alkyl and R^{b} is C(6)aryl optionally substituted with methyl or C(1-6)alkyl optionally substituted with C(6)aryl,
wherein R^{a} is C(4-5)heteroaryl-C(1-2)alkyl and R^{b} is C(1-2)alkyl, or
wherein R^{a} is C(2-3)alkyl and R^{b} is C(6)aryl-C(1-2)alkyl optionally substituted with one or more hydroxy or methoxy,
in a total amount of from 0.1 to 20 wt. % (calculated on the total weight of the composition), in particular 0.5 to 20 wt. %;
b) from 0.1 to 15 wt. % of hydrogen peroxide (calculated as the net weight of hydrogen peroxide on the total weight of the composition);
c) one or more compounds according to formula II:

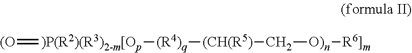

or a salt thereof,
   wherein: R² is H or OH; R³ is OH; each R⁴ is independently an alkylene radical containing 1-18 carbon atoms and each R⁶ is independently H or an alkyl radical containing 1-18 carbon atoms, with the proviso that R⁴+R⁶≤20 total carbon atoms; each R⁵ is independently H or CH₃; m is 1 or 2; each n is independently 2-10; and each p and q is independently 0 or 1 with the proviso that when p is 0, q is 1,
and/or according to formula III:

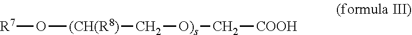

or a salt thereof,
   wherein R⁷ is C(6-12)alkyl or C(6-12)alkenyl, R⁸ is H or CH₃, and s is 3-10,
in a total amount of from 0.1 to 10 wt. % (calculated on the total weight of the composition); and
wherein the disinfecting composition has a pH of from 0.5 to 3.5.

The present disclosure relates to a disinfecting composition comprising:
a) one or more compounds according to formula I:

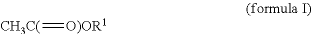

wherein R¹ is
   C(1-5)alkoxy-C(1-5)alkyl wherein the C(1-5)alkoxy is optionally substituted with one hydroxyl group or methyl ester,
   C(1-3)alkoxy-C(1-5)alkoxy-C(1-5)alkyl wherein the C(1-3)alkoxy is optionally substituted with one hydroxyl group or methyl ester,
   C(2-5)alkyl wherein the C(2-5)alkyl is substituted with one or two methyl esters and/or one or two hydroxyl groups, or
   C(2-5)alkyl,
in a total amount of from 0.1 to 20 wt. % (calculated on the total weight of the composition), in particular 0.5 to 20 wt. %;
b) from 0.1 to 15 wt. % of hydrogen peroxide (calculated as the net weight of hydrogen peroxide on the total weight of the composition);
c) one or more compounds according to formula II:

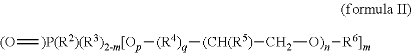

or a salt thereof,
   wherein: R² is H or OH; R³ is OH; each R⁴ is independently an alkylene radical containing 1-18 carbon atoms and each R⁶ is independently H or an alkyl radical containing 1-18 carbon atoms, with the proviso that R⁴+R⁶≤20 total carbon atoms; each R⁵ is independently H or CH₃; m is 1 or 2; each n is independently 2-10; and each p and q is independently 0 or 1 with the proviso that when p is 0, q is 1,
   and/or according to formula III:

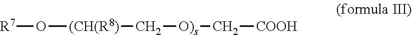

or a salt thereof,
   wherein R⁷ is C(6-12)alkyl or C(6-12)alkenyl, R⁸ is H or CH₃, and s is 3-10,
   in a total amount of from 0.1 to 10 wt. % (calculated on the total weight of the composition); and
   wherein the disinfecting composition has a pH of from 0.5 to 3.5.

### Compounds According to Formula I

The disinfecting composition comprises a compound according to formula I, CH₃C(═O)OR¹, wherein R¹ is
C(1-5)alkoxy-C(1-5)alkyl wherein the C(1-5)alkoxy is optionally substituted with one hydroxyl group or methyl ester,
C(1-3)alkoxy-C(1-5)alkoxy-C(1-5)alkyl wherein the C(1-3)alkoxy is optionally substituted with one hydroxyl group or methyl ester,
C(2-5)alkyl wherein the C(2-5)alkyl is substituted with one or two methyl esters and/or one or two hydroxyl groups,
C(2-12)alkyl, in particular C(2-5)alkyl,
C(2-12)alkenyl, in particular C(3-7)alkenyl,
C(2-12)alkynyl, in particular C(3-7)alkynyl, or
C(6)aryl-C(1-2)alkyl optionally substituted with one or more hydroxy, methoxy, amino, or C(1-3)alkyl groups,
   and/or one or more compounds according to formula Ia, R^{a}C(═O)OR^{b},
wherein R^{a} is C(6)aryl optionally substituted with hydroxyl, and R^{b} is a C(1-6)alkyl or C(6)aryl-(C1-2)alkyl,
wherein R^{a} is C(6)aryl-C(1-2)alkyl and R^{b} is C(6)aryl optionally substituted with methyl or C(1-6)alkyl optionally substituted with C(6)aryl,
wherein R^{a} is C(4-5)heteroaryl-C(1-2)alkyl and R^{b} is C(1-2)alkyl, or
wherein R^{a} is C(2-3)alkyl and R^{b} is C(6)aryl-C(1-2)alkyl optionally substituted with one or more hydroxy or methoxy.

Non-limiting examples of compounds according to formula I, wherein R¹ is C(1-5)alkoxy-C(1-5)alkyl wherein the C(1-5)alkoxy is optionally substituted with one hydroxyl group or methyl ester, are propylene glycol methyl ether acetate, 2-(2-hydroxyethoxy)ethyl acetate, and 2-(pentyloxy)ethyl acetate.

Non-limiting examples of compounds according to formula I, wherein R¹ is C(1-3)alkoxy-C(1-5)alkoxy-C(1-5)alkyl wherein the C(1-3)alkoxy is optionally substituted with one hydroxyl group or methyl ester, are dipropylene glycol methyl ether acetate, triethylene glycol diacetate, and tripropylene glycol diacetate.

Non-limiting examples of compounds according to formula I, wherein C(2-5)alkyl wherein the C(2-5)alkyl is substituted with one or two methyl esters and/or one or two hydroxyl groups, are ethylene glycol diacetate, propylene glycol diacetate, 1,3-butanediol diacetate, triacetin, diacetin, and monoacetin.

Non-limiting examples of compounds according to formula I, wherein R¹ is C(2-5)alkyl, are ethyl acetate, propylacetate, butylacetate, pentylacetate, and isoamylacetate. Other examples of compounds according to formula I, wherein R¹ is C(2-12)alkyl, are hexyl acetate, heptyl acetate, octyl acetate, nonyl acetate, decyl acetate, undecyl acetate, and dodecyl acetate.

Non-limiting examples of compounds according to formula I, wherein R¹ is C(2-12)alkenyl, in particular C(5-12)alkenyl, include cis-3-hexenyl methyl acetate.

Non-limiting examples of compounds according to formula I, wherein R¹ is C(2-12)alkynyl, in particular C(5-12)alkynyl, include methyl 2-octynoate.

Non-limiting examples of compounds according to formula I, wherein R¹ is C(6)aryl-C(1-2)alkyl optionally substituted with one or more hydroxy, methoxy, amino, or C(1-3)alkyl groups, are benzyl acetate, 4-hydroxybenzyl acetate, 4-methoxybenzyl acetate, 4-aminobenzyl acetate, (di)methylbenzyl acetate, 4-isopropylbenzyl acetate, and dimethylbenzylcarbinyl acetate.

Non-limiting examples of compounds according to formula Ia, wherein R^{a} is C(6)aryl optionally substituted with hydroxyl, and R^{b} is a C(1-6)alkyl or C(6)aryl-(C1-2)alkyl, are benzyl benzoate, hexyl salicylate and benzyl salicylate.

Non-limiting examples of compounds according to formula Ia, wherein R^{a} is C(6)aryl-C(1-2)alkyl and R^{b} is C(6)aryl optionally substituted with methyl or C(1-6)alkyl optionally substituted with C(6)aryl, are phenethyl phenylacetate, benzyl phenylacetate, ethyl phenylacetate, isoamyl phenylacetate, isobutyl phenylacetate, methyl phenylacetate, and p-tolyl phenylacetate.

Non-limiting examples of compounds according to formula Ia, wherein R^{a} is C(4-5)heteroaryl-C(1-2)alkyl and R^{b} is C(1-2)alkyl, are methyl 2-pyridylacetate, methyl 3-pyridylacetate, methyl 4-pyridylacetate, ethyl 2-pyridylacetate, ethyl 3-pyridylacetate, and ethyl 4-pyridylacetate.

Non-limiting examples of compounds according to formula Ia, wherein R^{a} is C(2-3)alkyl and R^{b} is C(6)aryl-C(1-2)alkyl optionally substituted with one or more hydroxy or methoxy, are benzyl butyrate, benzyl isobutyrate, and styrallyl propionate.

It may be preferred that, in the compound according to formula I, R¹ is C(1-5)alkoxy-C(1-5)alkyl wherein the C(1-5)alkoxy is optionally substituted with one hydroxyl group or methyl ester, C(1-3)alkoxy-C(1-5)alkoxy-C(1-5)alkyl wherein the C(1-3)alkoxy is optionally substituted with one hydroxyl group or methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, C(3-5)alkyl substituted with one or two methyl esters, C(3-7)alkenyl, C(3-7)alkynyl, or C(6)aryl-C(1-2)alkyl optionally substituted with one or more hydroxy, methoxy, amino, or C(1-3)alkyl groups.

It may be preferred that, in the compound according to formula I, R¹ is C(1-5)alkoxy-C(1-5)alkyl wherein the C(1-5)alkoxy is optionally substituted with one hydroxyl group or methyl ester, C(1-3)alkoxy-C(1-5)alkoxy-C(1-5)alkyl wherein the C(1-3)alkoxy is optionally substituted with one hydroxyl group or methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, C(3-5)alkyl substituted with one or two methyl esters, or C(3-7)alkynyl.

It may be preferred that, in the compound according to formula I, CH₃C(═O)OR¹, R¹ is C(1-5)alkoxy-C(1-5)alkyl wherein the C(1-5)alkoxy is optionally substituted with one hydroxyl group or methyl ester, C(1-3)alkoxy-C(1-5)alkoxy-C(1-5)alkyl wherein the C(1-3)alkoxy is optionally substituted with one hydroxyl group or methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, or C(3-5)alkyl substituted with one or two methyl esters.

It may be preferred that, in the compound according to formula I, R¹ is C(1-5)alkoxy-C(2-3)alkyl wherein the C(1-5)alkoxy is optionally substituted with one hydroxyl group or methyl ester, C(1-3)alkoxy-C(2-3)alkoxy-C(2-3)alkyl wherein the C(1-3)alkoxy is optionally substituted with one hydroxyl group or methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, or C(3-5)alkyl substituted with one or two methyl esters.

It may be more preferred that, in the compound according to formula I, R¹ is C(1)alkoxy-C(1-5)alkyl, C(1)alkoxy-C(1-5)alkoxy-C(1-5)alkyl, C(2-3)alkoxy-C(1-5)alkoxy-C(1-5)alkyl wherein the C(2-3)alkoxy is substituted with one methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, or C(3-5)alkyl substituted with one or two methyl esters.

It may be more preferred that, in the compound according to formula I, R¹ is C(2-3)alkoxy-C(1-5)alkoxy-C(1-5)alkyl wherein the C(2-3)alkoxy is optionally substituted with one methyl ester, C(2)alkyl substituted with one hydroxyl group or one methyl ester, C(3-5)alkyl substituted with one hydroxyl group and one methyl ester, C(3-5)alkyl substituted with two hydroxyl groups, or C(3-5)alkyl substituted with two methyl esters.

It may be more preferred that, in the compound according to formula I, R¹ is C(1)alkoxy-C(2-3)alkyl, C(1)alkoxy-C(2-3)alkoxy-C(2-3)alkyl, C(2)alkyl substituted with one hydroxyl group or one methyl ester, C(3-5)alkyl substituted with one hydroxyl group and one methyl ester, C(3-5)alkyl substituted with two hydroxyl groups, or C(3-5)alkyl substituted with two methyl esters.

It may be more preferred that, in the compound according to formula I, R¹ is C(2)alkyl substituted with one hydroxyl group or one methyl ester, C(3-5)alkyl substituted with one hydroxyl group and one methyl ester, C(3-5)alkyl substituted with two hydroxyl groups, or C(3-5)alkyl substituted with two methyl esters.

It may be more preferred that, in the compound according to formula I, R¹ is C(1)alkoxy-C(3)alkyl, C(1)alkoxy-C(3)alkoxy-C(3)alkyl, C(2)alkyl substituted with one hydroxyl group or one methyl ester, C(3)alkyl substituted with one hydroxyl group and one methyl ester, C(3)alkyl substituted with two hydroxyl groups, or C(3)alkyl substituted with two methyl esters.

In some embodiments, the compound of formula I is selected from the group consisting of propylene glycol methyl ether acetate, 2-(2-hydroxyethoxy)ethyl acetate, 2-(pentyloxy)ethyl acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, ethyl acetate, propyl acetate, butyl acetate, pentyl acetate, isoamyl acetate, hexyl acetate, heptyl acetate, octyl acetate, nonyl acetate, decyl acetate, undecyl acetate, dodecyl acetate, cis-3-hexenyl methyl acetate, methyl 2-octynoate benzyl acetate, 4-hydroxybenzyl acetate, 4-methoxybenzyl acetate, 4-aminobenzyl acetate, (di)methylbenzyl acetate, 4-isopropylbenzyl acetate, and dimethylbenzylcarbinyl acetate.

In some embodiments, the compound of formula I is selected from the group consisting of propylene glycol methyl ether acetate, 2-(2-hydroxyethoxy)ethyl acetate, 2-(pentyloxy)ethyl acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, propyl acetate, butyl acetate, pentyl acetate, isoamyl acetate, hexyl acetate, heptyl acetate, octyl acetate, methyl 2-octynoate benzyl acetate, (di)methylbenzyl acetate, 4-isopropylbenzyl acetate, and dimethylbenzylcarbinyl acetate.

It may be more preferred that the compound of formula I is selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, isoamylacetate, propylacetate, butylacetate, pentylacetate, 2-(2-hydroxyethoxy)ethyl acetate, and 2-(pentyloxy)ethyl acetate. The disinfecting composition may comprise at least one compound selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, isoamyl acetate, propyl acetate, butyl acetate, pentyl acetate, 2-(2-hydroxyethoxy)ethyl acetate, and 2-(pentyloxy)ethyl acetate and one or more further compounds according to formula I. For example, the disinfecting composition may comprise two or more compounds selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, isoamylacetate, propyl acetate, butyl acetate, pentyl acetate, 2-(2-hydroxyethoxy)ethyl acetate, and 2-(pentyloxy)ethyl acetate.

It may be more preferred that the compound of formula I is selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, 2-(2-hydroxyethoxy)ethyl acetate, and 2-(pentyloxy)ethyl acetate. The disinfecting composition may comprise at least one compound selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, 2-(2-hydroxyethoxy)ethyl acetate, and 2-(pentyloxy)ethyl acetate and one or more further compounds according to formula I. For example, the disinfecting composition may comprise two or more compounds selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, 2-(2-hydroxyethoxy)ethyl acetate, and 2-(pentyloxy)ethyl acetate.

It may be more preferred that the compound of formula I is selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin. The disinfecting composition may comprise at least one compound selected from the group consisting of propylene glycol methyl ether acetate, dipropylene glycol methyl ether acetate, triethylene glycol diacetate, tripropylene glycol diacetate, ethylene glycol diacetate, and propylene glycol diacetate, 1,3-butanediol diacetate, triacetin, and diacetin and one or more further compounds according to formula I. For example, the disinfecting composition may comprise two or more compounds selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin.

It may be more preferred that the compound of formula I is selected from the group consisting of triethylene glycol diacetate, tripropylene glycol diacetate, ethylene glycol diacetate, propylene glycol diacetate, 1,3-butanediol diacetate, triacetin, and diacetin. The disinfecting composition may comprise at least one compound selected from the group consisting of triethylene glycol diacetate, tripropylene glycol diacetate, ethylene glycol diacetate, propylene glycol diacetate, 1,3-butanediol diacetate, triacetin, and diacetin and one or more further compounds according to formula I. For example, the disinfecting composition may comprise two or more compounds selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin.

It may be more preferred that the compound of formula I is selected from the group consisting of propylene glycol methyl ether acetate, dipropylene glycol methyl ether acetate, propylene glycol diacetate, and triacetin. The disinfecting composition may comprise at least one compound selected from the group consisting of propylene glycol methyl ether acetate, dipropylene glycol methyl ether acetate, propylene glycol diacetate, and triacetin and one or more further compounds according to formula I. The disinfecting composition preferably comprises triacetin and one or more further compounds according to formula I. For example, the disinfecting composition may comprise two or more compounds selected from the group consisting of propylene glycol methyl ether acetate, dipropylene glycol methyl ether acetate, propylene glycol diacetate, and triacetin. In a particular embodiment, the compound according to formula I is triacetin.

In some embodiments, the disinfecting composition comprises one or more compounds according to formula Ia, R^{a}C(═O)OR^{b}, wherein
R^{a} is C(6)aryl optionally substituted with hydroxyl, and R^{b} is C(1-6)alkyl or C(6)aryl-(C1-2)alkyl,
R^{a} is C(6)aryl-C(1-2)alkyl and R^{b} is C(6)aryl optionally substituted with methyl or C(1-6)alkyl optionally substituted with C(6)aryl, or
R^{a} is C(2-3)alkyl and R^{b} is C(6)aryl-C(1-2)alkyl optionally substituted with one or more hydroxy or methoxy.

In some embodiments, the disinfecting composition comprises one or more compounds according to formula Ia, R^{a}C(═O)OR^{b}, wherein
R^{a} is C(6)aryl optionally substituted with hydroxyl, and R^{b} is C(1-6)alkyl or C(6)aryl-(C1-2)alkyl, or
R^{a} is C(6)aryl-C(1-2)alkyl and R^{b} is C(6)aryl optionally substituted with methyl or C(1-6)alkyl optionally substituted with C(6)aryl.

In some embodiments, the disinfecting composition comprises one or more compounds according to formula Ia, R^{a}C(═O)OR^{b}, wherein
R^{a} is C(6)aryl and R^{b} is C(6)aryl-(C1-2)alkyl, or
R^{a} is C(6)aryl substituted with hydroxyl and R^{b} is a C(1-6)alkyl.

In some embodiments, the one or more compounds according to formula Ia are selected from the group consisting of benzyl benzoate, hexyl salicylate, benzyl salicylate, phenethyl phenylacetate, benzyl phenylacetate, ethyl phenylacetate, isoamyl phenylacetate, isobutyl phenylacetate, methyl phenylacetate, p-tolyl phenylacetate, methyl 2-pyridylacetate, methyl 3-pyridylacetate, methyl 4-pyridylacetate, ethyl 2-pyridylacetate, ethyl 3-pyridylacetate, ethyl 4-pyridylacetate, benzyl butyrate, benzyl isobutyrate, and styrallyl propionate.

In some embodiments, the one or more compounds according to formula Ia are selected from the group consisting of benzyl benzoate, hexyl salicylate, benzyl salicylate, phenethyl phenylacetate, benzyl phenylacetate, ethyl phenylacetate, isoamyl phenylacetate, isobutyl phenylacetate, ethyl 4-pyridylacetate benzyl butyrate, benzyl isobutyrate, and styrallyl propionate.

The disinfecting composition comprises the compound of formula I and/or the compound of formula Ia in a total amount of from 0.1 to 20 wt. % (calculated on the total weight of the disinfecting composition). The compound of formula I and/or the compound of formula Ia may be present in a total amount of from 0.2 to 20 wt. % (calculated on the total weight of the disinfecting composition), in particular 0.3 to 20 wt. %, more in particular 0.4 to 20 wt. %, even more in particular 0.5 to 20 wt. %, even more in particular 0.8 to 15 wt. %, even more in particular 1.0 to 10 wt. %, even more in particular 1.5 wt. % to 8.0 wt. %.

The disinfecting composition may comprise the compound of formula I in a total amount of from 0.1 to 20 wt. % (calculated on the total weight of the disinfecting composition). The compound of formula I may be present in a total amount of from 0.2 to 20 wt. % (calculated on the total weight of the disinfecting composition), in particular 0.3 to 20 wt. %, more in particular 0.4 to 20 wt. %, even more in particular 0.5 to 20 wt. %, even more in particular 0.8 to 15 wt. %, even more in particular 1.0 to 10 wt. %, even more in particular 1.5 wt. % to 8.0 wt. %.

The disinfecting composition may comprise the compound of formula Ia in a total amount of from 0.1 to 20 wt. % (calculated on the total weight of the disinfecting composition). The compound of formula I may be present in a total amount of from 0.2 to 20 wt. % (calculated on the total weight of the disinfecting composition), in particular 0.3 to 20 wt. %, more in particular 0.4 to 20 wt. %, even more in particular 0.5 to 20 wt. %, even more in particular 0.8 to 15 wt. %, even more in particular 1.0 to 10 wt. %, even more in particular 1.5 wt. % to 8.0 wt. %.

### Hydrogen Peroxide

The disinfecting composition comprises hydrogen peroxide in an amount of 0.1 to 15 wt. % (calculated as the net weight of hydrogen peroxide on the total weight of the composition). Hydrogen peroxide is particularly attractive as a biocidally active compound because its decomposition products, water and oxygen, are not toxic and not harmful to the environment.

The disinfecting composition may comprise the hydrogen peroxide in an amount of from 0.2 to 7.0 wt. % (calculated as the net weight of hydrogen peroxide on the total weight of the composition), in particular from 0.3 to 6.0 wt. %, more in particular from 0.4 to 5.0 wt. %, more in particular 0.5 to 3.0 wt. %. These concentrations were found to be particularly useful in disinfecting compositions for application, because they aid in achieving surprisingly fast and effective antimicrobial action with good material compatibility.

In order to provide fast, effective action, biocidal hydrogen peroxide solutions previously had to employ relatively high concentrations of hydrogen peroxide. However, at such higher concentrations, the solutions may be subject to hazardous goods regulations and may require special precautions for handling and use. For example, at concentrations of above about 7.5 wt. % aqueous solution, hydrogen peroxide is considered corrosive and is also a strong oxidizing agent. Surprisingly, it has been found that the use of relatively limited amounts of hydrogen peroxide in the disinfecting compositions according to the disclosure can, in combination with the other compounds of the present composition, provide good antifungal, antiviral and antibacterial activity against difficult-to-kill fungi, viruses and bacteria.

The disinfecting composition may also comprise the hydrogen peroxide in an amount of from 7.5 to 15 wt. % (calculated as the net weight of hydrogen peroxide on the total weight of the composition), in particular from 5.0 to 12 wt. %. These concentrations are particularly useful in sporicidal disinfecting compositions, i.e., in sterilants.

The weight ratio of the total weight of the compounds according to formula I(a) to the net weight of the hydrogen peroxide is from 5:1 to 1:5. In some embodiments, the ratio of the total weight of the compounds according to formula (a) to the net weight of the hydrogen peroxide is from 4:1 to 1:4, in particular from 3:1 to 1:3, more in particular from 1:1 to 1:2.5.

### Compounds According to Formula II

The disinfecting composition may comprise one or more compounds according to formula II, (O═)P(R²)(R³)₂₋ₘ[Oₚ—(R⁴)_{q}—(CH(R⁵)—CH₂—O)ₙ—R⁶]ₘ, or a salt thereof, wherein: R² is H or OH; R³ is OH; each R⁴ is independently an alkylene radical containing 1-18 carbon atoms and each R⁶ is independently H or C(1-18)alkyl, with the proviso that R⁴+R⁶≤20 total carbon atoms; each R⁵ is independently H or CH₃; m is 1 or 2; each n is independently 2-10; and each p and q is independently 0 or 1 with the proviso that when p is 0, q is 1.

The disinfecting composition preferably comprises one or more compounds according to formula II, (O═)P(R²)(R³)₂₋ₘ[Oₚ—(R⁴)_{q}—(CH(R⁵)—CH₂—O)ₙ—R⁶]ₘ or a salt thereof, wherein: R² is H or OH; R³ is OH; each R⁴ is independently an alkylene radical containing 1-18 carbon atoms and each R⁶ is independently H or C(1-18)alkyl, with the proviso that R⁴+R⁶≤20 total carbon atoms; each R⁵ is independently H or CH₃; m is 1 or 2; each n is independently 2-10; and each p and q is independently 0 or 1 with the proviso that when p is 0, q is 1.

In particular, the compound may be a compound according to formula II, wherein R² is OH. In particular, the compound may be a compound according to formula II, wherein each R⁴ is independently an alkylene radical containing 6-16 carbon atoms, more in particular 8-14 carbon atoms, more in particular 10-12 carbon atoms, with the proviso that R⁴+R⁶≤20 total carbon atoms. In particular, the compound may be a compound according to formula II, wherein R⁵ is H. In particular, the compound may be a compound according to formula II, wherein each R⁶ is a C(6-16)alkyl, more in particular a C(8-14)alkyl, more in particular a C(10-12)alkyl, with the proviso that R⁴+R⁶≤20 total carbon atoms. In particular, the compound may be a compound according to formula II, wherein m is 1. In particular, the compound may be a compound according to formula II, wherein each n is independently 2-8, more in particular 2-6, more in particular 4-6. In particular, the compound may be a compound according to formula II, wherein p is 1 and q is 0. Combinations of the features defined in this paragraph are also envisaged.

The compound according to formula II is preferably a compound according to formula IIa: (O═)P(R²)(R³)(—O—(CH(R⁵)—CH₂—O)ₙ—R⁶) (formula IIa), or a salt thereof, wherein: R² is H or OH; R³ is OH; R⁵ is H or CH₃; n is 4-6; and R⁶ is C(4-18)alkyl. More in particular, it may be a compound according to formula IIa, wherein: R² is OH; R³ is OH; R⁵ is H or CH₃; n is 4-6; and R⁶ is C(4-18)alkyl. More in particular, it may be a compound according to formula IIa, wherein: R² is OH; R³ is OH; R⁵ is H; n is 4-6; and R⁶ is C(4-18)alkyl. More in particular, it may be a compound according to formula IIa, wherein: R² is OH; R³ is OH; R⁵ is H; n is 4; and R⁶ is C(4-18)alkyl. More in particular, it may be a compound according to formula IIa, wherein: R² is OH; R³ is OH; R⁵ is H; n is 4; and R⁶ is C(8-14)alkyl.

The one or more compounds according to formula II, including the one or more compounds according to formula IIa, may be present in the disinfection composition in a total amount of from 0 (in which case the composition must contain at least one compound according to formula III) to 10 wt. %, such as 0.1 to 10 wt. % (calculated on the total weight of the composition), in particular in an amount of from 0.2 to 8.0 wt. %, more in particular in an amount of from 0.3 to 6.0 wt. %, more in particular in an amount of from 0.5 to 5.0 wt. %, more in particular in an amount of from 0.8 to 4.0 wt. %.

In some embodiments, the disinfecting composition comprises at most 5.0 wt. % of the one or more compounds according to formula II (calculated on the total weight of the composition), in particular at most 4.0 wt. %, more in particular at most 3.0 wt. %, more in particular at most 3.0 wt. %, more in particular at most 2.0 wt. %, more in particular at most 1.0 wt. %, more in particular at most 0.5 wt. %.

Suitable salts of the compounds according to formula II and IIa include soluble salts of alkali metals, earth alkali metals, and ammonia, in particular sodium salts, potassium salts, and ammonium salts. Preferably, however, the compound according to formula II and IIa is a free acid.

### Compounds According to Formula III

The disinfecting composition may comprise one or more compounds according to formula III, R⁷—O—(CH(R⁸)—CH₂—O)ₛ—CH₂—COOH, or a salt thereof, wherein R⁷ is a C(6-12)alkyl or C(6-12)alkenyl, R⁸ is H or CH₃, and s is 3-10.

In the compounds of formula III, R⁷ is preferably a C(6-10)alkyl or C(6-10)alkenyl, in particular C(6-8)alkyl or C(6-8)alkenyl. Preferably, R⁷ is a straight-chain alkyl group. Preferably, R⁷ is a (straight-chain) C(6-12)alkyl, more preferably a (straight-chain) C(6-10)alkyl, more preferably a (straight-chain) C(6-8)alkyl. Depending on the nature of R⁸, the compound according to formula III may contain ethoxy moieties, propoxy moieties or both ethoxy moieties and propoxy moieties. An individual compound with a structure according to formula III may further contain only propoxy or only ethoxy groups or may contain a mixture of ethoxy and propoxy groups. It is preferred for s to be in the range of 3-8. Preferably, s is 3-8 and/or R⁸ is H.

Preferred compounds according to formula III include compounds wherein R⁷ is a straight chain C(6-12)alkyl, R⁸ is H, and s is 3-8; compounds wherein R⁷ is a straight-chain C(6)alkyl, R⁸ is H, and s is 3-8; and compounds wherein R⁷ is a straight-chain C(8)alkyl, R⁸ is H, and s is 5-8; and salts thereof, and combinations thereof.

More preferred compounds according to formula III include compounds wherein R⁷ is a straight-chain C(6)alkyl, R⁸ is H, and s is 3; compounds wherein R⁷ is a straight-chain C(8)alkyl, R⁸ is H, and s is 8; and compounds wherein R⁷ is a straight-chain C(8)alkyl, R⁸ is H, and s is 5; and combinations thereof.

Suitable salts of the compounds according to formula III include soluble salts of alkali metals, earth alkali metals, and ammonia, in particular sodium salts, potassium salts, and ammonium salts. Preferably, however, compound according to formula III is a free acid.

Compounds according to formula III are commercially available. Suitable compositions include for example the surfactants marketed under the trade names AKYPO LF1, AKYPO LF2, AKYPO LF4 and AKYPO LF6 (from KAO Chemicals).

The one or more compounds according to formula III may be present in the disinfection composition in a total amount of from 0 (in which case the composition must contain at least one compound according to formula II and/or IIa) to 10 wt. %, such as 0.1 to 10 wt. % (calculated on the total weight of the composition), in particular in an amount of from 0.2 to 8.0 wt. %, more in particular in an amount of from 0.3 to 7.0 wt. %, more in particular in an amount of from 0.5 to 6.0 wt. %, more in particular in an amount of from 0.8 to 4.0 wt. %, more in particular in an amount of from 1.0 to 2.0 wt. %.

In some embodiments, the disinfecting composition comprises at most 5.0 wt. % of the one or more compounds according to formula III (calculated on the total weight of the composition), in particular at most 4.0 wt. %, more in particular at most 3.0 wt. %, more in particular at most 2.0 wt. %, more in particular at most 1.0 wt. %, more in particular at most 0.5 wt. %, more in particular less than 0.1 wt. %.

In some embodiments, the compounds according to formulae II/IIa and III may both be present. The one or more compounds according to formulae II/IIa and III may be present in the disinfection composition in a total amount of from 0.1 to 10 wt. % (calculated on the total weight of the composition), in particular in a total amount of from 0.2 to 8.0 wt. %, more in particular in a total amount of from 0.3 to 7.0 wt. %, more in particular in a total amount of from 0.5 to 6.0 wt. %, more in particular in a total amount of from 0.8 to 5.0 wt. %, more in particular in a total amount of from 1.0 to 4.0 wt. %, more in particular in a total amount of from 1.5 to 3.0 wt. %.

### Ph of the Disinfecting Composition

The disinfecting composition has a pH of from 0.5 to 3.5. The disinfecting composition may have a pH of from 1.0 to 3.0, in particular 1.5 to 2.5. It has been found that the disinfecting composition achieves optimal antimicrobial activity within the above-mentioned range. At higher pH values, the antimicrobial activity drops, leaving a composition with little to no antimicrobial activity.

A pH-adjusting acid or base, or an appropriate buffer, may be used to provide the disinfecting composition with the pH defined above. Suitable acids are organic and inorganic acids. The disinfection composition may, for example, further comprise a carboxylic acid. Suitable carboxylic acids are carboxylic acids selected from the group consisting of lactic acid, tartaric acid, acetic acid, succinic acid, benzoic acid, salicylic acid, malic acid, maleic acid, citric acid, glycolic acid, furoic acid, and fumaric acid. Particularly, the carboxylic acids may be benzoic acid, salicylic acid, or a mixture thereof. In particular embodiments, the disinfecting compositions composition comprises benzoic acid and salicylic acid. Suitable inorganic acids are phosphoric acid, sulfamic acid, nitric acid, methane sulphonic acid, and sulphuric acid, of which phosphoric acid, sulfamic acid or methane sulphonic acid may be preferred. The organic acids and inorganic acids mentioned above may be present in the disinfecting composition in a total amount of from 0.05 to 2.0 wt. % (calculated on the total weight of the composition), in particular 0.1 to 1.5 wt. %, more in particular 0.2 to 1.0 wt. %, more in particular 0.3 to 0.8 wt. %, even more in particular 0.5 to 0.8 wt. %. Combinations of (organic and inorganic) acids may be used.

Suitable bases are organic and inorganic bases. For example, the disinfecting composition may further comprise a hydroxide salt (e.g., NaOH, KOH) or a (bi) carbonate salt (e.g. Na₂CO₃, K₂CO₃). The organic bases and inorganic bases mentioned above may be present in the disinfecting composition in a total amount of from 0.1 to 2.0 wt. % (calculated on the total weight of the composition), in particular 0.2 to 1.0 wt. %. Combinations of (organic and inorganic) bases may be used.

### Other Components

The disinfecting composition may optionally further comprise a peroxy acid or a precursor thereof. Suitable peroxy acids can be organic or inorganic peroxy acids. For example, the disinfecting composition may further comprise a percarboxylic acid or a precursor thereof, more in particular a percarboxylic acid or precursor thereof selected from the group consisting of peracetic acid, perpropionic acid, percitric acid, perlactic acid, performic acid, pertartaric acid, persuccinic acid, perbenzoic acid, persalisylic acid, permalic acid, permaleic acid, perglycolic acid, perfuroic acid, perfumaric acid, and precursors thereof, more in particular a percarboxylic acid or precursor thereof selected from the group consisting of peracetic acid, perpropionic acid, percitric acid, perlactic acid, and precursors thereof, more in particular peracetic acid or a precursor thereof. An example of a suitable inorganic peroxy acid is peroxymonosulphuric acid.

The disinfecting composition may optionally further comprise a (hydrogen) peroxide stabilizer. Such stabilizer may preferably be a sequestering agent or chelating agent. In general, a chelating agent is a molecule capable of coordinating (i.e., binding) the metal ions commonly found in water sources to prevent the metal ions from interfering with the action of the other ingredients. Preferred are chelating agents with a high binding affinity at low pH, and good water solubility at low pH. Examples of chelating agents include phosphonic acid and phosphonates, phosphates, aminocarboxylates and their derivatives, pyrophosphates, ethylenediamine and ethylenetriamine derivatives, hydroxyacids, and mono-, di-, and tri-carboxylates and their corresponding acids. Other chelating agents include nitroloacetates and their derivatives, and mixtures thereof, ethylenediaminetetraacetic acid (EDTA), diethylenetriaminepentaacetic acid (DTPA), N-(hydroxyethyl)-ethylenediaminetriacetic acid (HEDTA), nitrilotriacetic acid (NTA), 2-hydroxyethyliminodiacetic acid (HEIDA), and salts thereof or from benzoic acid, salicylic acid, aminobenzoic acid, citric acid, phosphoric acid, iminodisuccinic acid and polyaspartic acid. More preferably, the chelating agent is a (colloidal) stannate, and even more preferably is chosen from acetanilide, trisodium ethylenediamine disuccinate (EDDS), for instance OctaQuest E30 or A65 (Octel), derivatives of glutamic acid, such as glutamic acid diacetic acid (tetra) sodium salt (GLDA), iminodisuccinic acid and salts (IDS), organophosphonic acid derivatives, and its salts, having 1 to 5 phosphonic acid groups, for instance a Dequest phosphonate (Solutia), such as for example 1-hydroxyethylidene-1,1-diphosphonic acid, amino tri(methylene phosphonic acid), diethylenetriamine-penta(methylene phosphonic acid), 2-hydroxy ethylimino bis(methylene phosphonic acid), ethylene diamine tetra(methylene phosphonic acid), and pyridine carboxylic acid-based stabilizers (such as picolinic acids and salts thereof) can be used. The use of phosphonic acid and its derivatives is considered preferred. However, the list of chelating agents does not imply to limit the selection to these substances. It is clear to the skilled person that any substance with chelating or metal-ion binding capacities may be selected. The disinfecting composition may comprise 0.01-2.0 wt. % of a sequestering agent (calculated on the total weight of the composition). The chelating agent is preferably present in an amount of 0.01-2.0 wt. % (calculated on the total weight of the composition), in particular 0.05-1.5 wt. %, more in particular 0.1-1.0 wt. %. Mixtures of different sequestering agents and/or chelating agents may also be used.

In view of their high binding activity at low pH and good water solubility at low pH, organophosphonates, cyclic carboxylic acids, and aminopolycarboxylic acids (such as GLDA, IDS and EDDS) may be particularly preferred.

The disinfecting composition is generally water-based, i.e., aqueous. Thus, the composition may comprise water. For example, the disinfecting composition may comprise from 55 to 99.3 wt. % of water (based on the total weight of the composition), in particular 75 to 98 wt. % of water, more in particular 80 to 97 wt. % of water, even more in particular 85 to 95 wt. % of water. For example, the disinfecting composition may, in particular, comprise one or more compounds according to formula I in a total amount of from 0.5 to 10.0 wt. %; from 0.1 to 6.0 wt. % of hydrogen peroxide; one or more compounds according to formula II (a) and/or according to formula III in a total amount of from 0.1 to 5.0 wt. %; and 75 to 99.3 wt. % water (calculated on the total weigh of the composition).

The disinfecting composition may optionally comprise a further solvent selected from the group consisting of propylene glycol methyl ether, dipropylene glycol methyl ether, tripropylene glycol methyl ether, propylene glycol n-propyl ether, dipropylene glycol n-propyl ether, propylene glycol n-butyl ether, dipropylene glycol n-butyl ether, tripropylene glycol n-butyl ether, propylene glycol phenyl ether, dipropylene glycol phenyl ether, dipropylene glycol dimethyl ether, diethylene glycol methyl ether, triethylene glycol methyl ether, diethylene glycol ethyl ether, triethylene glycol ethyl ether, ethylene glycol propyl ether, ethylene glycol n-butyl ether, diethylene glycol n-butyl ether, triethylene glycol n-butyl ether, ethylene glycol hexyl ether, diethylene glycol hexyl ether, ethylene glycol phenyl ether, and diethylene glycol phenyl ether. The further solvent may, in particular, be propylene glycol n-butyl ether, dipropylene glycol n-butyl ether, or a mixture thereof. The further solvent may, more in particular, be propylene glycol n-butyl ether. The further solvent may be present in an amount of from 0.1 to 10 wt. % (calculated on the total weight of the composition), even more in particular 0.5 to 8.0 wt. %, still more in particular 1.0 to 5.0 wt. %. In some embodiments, the disinfecting composition comprises less than 3.0 wt. % of a further solvent defined above (calculated on the total weight of the composition), in particular less than 2.0 wt. %, more in particular less than 1.0 wt. %, more in particular less than 0.5 wt. %, more in particular less than 0.1 wt. %. In some embodiments, the disinfecting composition comprises less than 3.0 wt. % of propylene glycol n-butyl ether and/or dipropylene glycol n-butyl ether (calculated on the total weight of the composition), in particular less than 2.0 wt. %, more in particular less than 1.0 wt. %, more in particular less than 0.5 wt. %, more in particular less than 0.1 wt. %.

The disinfecting composition may further comprise a non-ionic surfactant. For example, the disinfecting composition may comprise an alkyl polyglucoside. Suitable alkyl polyglucosides are alkyl polyglucosides according to formula IV:

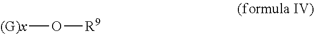

wherein G is a reducing saccharide moiety comprising 5 or 6 carbon atoms (in particular, 6 carbon atoms), R⁹ is a straight-chain or branched alkyl or alkylene group having 6-10 carbon atoms, and x represents the number of monosaccharide repeating units in the polyglucoside, wherein x is 1-8 (in particular, x is 1-5; more in particular, x is 1-3). The alkyl polyglucoside may preferably comprise the saccharide or polysaccharide groups (i.e., mono-, di-, tri-, etc. saccharides) of hexose or pentose, and a fatty aliphatic group with 6 to 20 carbon atoms. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in the making of polyglycosides. Examples of commercial suppliers of alkyl polyglucosides are Dow, BASF, Seppic, Akzo Nobel, and Croda. Functionalized alkyl polyglucosides may also be included, with cationic, amphoteric, or anionic functional groups.

The disinfecting composition according to the disclosure may comprise the alkyl polyglucoside in an amount of from 0.01 to 5.0 wt. % (calculated on the total weight of the composition), in particular in an amount of from 0.05 to 1.0 wt. %.

The disinfecting composition may comprise less than 0.75 wt. % of an amine oxide surfactant (calculated on the total weight of the composition). Particularly, the disinfecting composition may comprise less than 0.1 wt. % of an amine oxide surfactant, more in particular less than 0.05 wt. % of an amine oxide surfactant, more in particular be substantially free from amine oxide surfactants. The amine oxide surfactant may be an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition may comprise from 0.05 to 5.0 wt. % of an N-acylated amino acid or salt thereof, in particular from 0.1 to 3.0 wt. % of the N-acylated surfactant or salt thereof. The N-acylated amino acid may have a structure according to formula V:

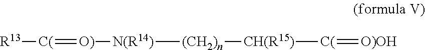

or a salt thereof,
wherein R¹³—CO— represents an acyl group wherein R¹³ is a C(5-21)alkyl radical or a C(5-21)alkylene radical, R¹⁴ is H or CH₃, R¹⁵ represents an amino acid side-chain or is H, and n is 0, 1 or 2. In particular embodiments of the structure according to formula IV, R¹³ is C(5-21)alkyl, in particular C(5-21)alkyl, more in particular C(5-14)alkyl, more in particular a straight-chain C(5-14)alkyl. In particular embodiments of the structure according to formula IV, R¹⁴ is CH₃. In particular embodiments of the structure according to formula IV, R¹⁵ is H. In particular embodiments of the structure according to formula IV, R¹⁵ represents a side-chain of an amino acid selected from the group consisting of glutamic acid, glutamate, aspartic acid, glutamine, glycine, asparagine, lysine, arginine, histidine, proline, sarcosine, threonine or serine, in particular a side-chain of an amino acid selected from the group consisting of glutamic acid, glutamate, sarcosine, glycine, aspartic acid and lysine. The N-acylated amino acid or a salt thereof is preferably an N-acylated sarcosinate or a salt thereof. In some embodiments, the disinfecting composition comprises less than 0.1 wt. % of an N-acylated amino acid (calculated on the total weight of the composition) or salt thereof, in particular less than 0.1 wt. % of an N-acylated sarcosine or salt thereof (such as lauroyl sarcosine, lauroyl sarcosine sodium salt and cocoyl sarcosine).

The disinfecting composition may comprise an anionic surfactant. The anionic surfactant may be an ethoxylated anionic surfactant, such as salts of laureth sulphate, capryleth sulphate, myreth sulphate, and steareth sulphate. The anionic surfactant is preferably a non-ethoxylated anionic surfactant. Suitable non-ethoxylated anionic surfactants can be selected from the group consisting of salts of alkyl sulphates, salts of cycloalkyl sulphates, salts of alkylaryl sulphates (e.g. sodium xylene sulphate, sodium dodecylbenzene sulphate), salts of arylalkyl sulphates, salts of alkyl phosphates, salts of alkyl carboxylates, salts of alkyl lactylates, salts of alkyl sulphoacetates, salts of alkyl sulphosuccinates, salts of sulpholaurates, salts of anionic alkyl polyglucosides, salts of alkyl taurates and salts of alkyl isethionates. The (cyclo)alkyl groups of these non-ethoxylated anionic surfactants may have 4-22 carbon atoms, in particular 8-18 carbon atoms, more in particular 10-18 carbon atoms. Suitable salts of the (non-)ethoxylated anionic surfactants are sodium salts, potassium salts, ammonium salts, etc. The ((non-)ethoxylated) anionic surfactant may be present in the disinfecting composition in an amount of 0.2 to 5.0 wt. % (calculated on the total weight of the composition), in particular in an amount of from 0.2 to 3.0 wt. %, more in particular in an amount of from 0.3 to 2.0 wt. %.

The disinfecting composition may comprise a betaine amphoteric surfactant. Examples of betaine amphoteric surfactants are cocobetaine and cocoamidopropyl betaine. Thus, the betaine amphoteric surfactant may be a C(6-16)alkyl betaine. The betaine amphoteric surfactant may be present in an amount of from 0.1 to 5.0 wt. % (calculated on the total weight of the composition).

The disinfecting composition may comprise less than 3.0 wt. % of benzyl alcohol (calculated on the total weight of the composition), in particular less than 2.0 wt. % of benzyl alcohol, in particular less than 1.0 wt. % of benzyl alcohol, in particular less than 0.5 wt. % of benzyl alcohol, in particular less than 0.3 wt. % of benzyl alcohol, more in particular less than 0.1 wt. % of benzyl alcohol. As shown in the Examples, the use of benzyl alcohol as a solvent may be detrimental to material compatibility when used in amounts of greater than 3.0 wt. %.

The disinfecting composition is suitable for disinfecting a surface (suspected of being) infected with bacteria (in particular, Staphylococcus aureus), and/or fungi (in particular Candida auris) and/or a non-enveloped virus (in particular, Norovirus and/or Feline Calicivirus). In some embodiments, the disinfecting composition passes the ASTM E1053-20 standard for viruses against Feline Calicivirus (the official USA EPA surrogate virus for Human Norovirus), as amended for impregnated towelettes in 60 seconds or less, in particular in 50 seconds or less (i.e., displays a log reduction of at least 3.0 against Feline Calicivirus). In some embodiments, the disinfecting composition passes the Germicidal Towelette Method/AOAC Official Method 961.02 for impregnated towelettes in 60 seconds or less, in particular in 50 seconds or less (i.e., having sufficient germkill against S. aureus in a Germicidal Towelette Method/AOAC Official Method 961.02 test where a total of sixty (60) carriers, with approximately 10⁵ colony forming units of the test germ, are tested per lot of disinfectant. Three lots of the test disinfectant, one lot must be at least 60 days old, must demonstrate 59/60 carriers negative for growth of the test germ. A total of sixty (60) carriers will test per lot of disinfectant per test germ). In some embodiments the product passes the OECD Quantitative Method for Evaluating the Efficacy of Antimicrobial Products against Candida auris on Hard, Non-Porous Surfaces (i.e., displays a log reduction of at least 5.0 against Candida auris).

The disinfecting composition may comprise less than 10 wt. % silica (calculated on the total weight of the composition), in particular less than 2.5 wt. %.

The disinfecting composition may comprise less than 0.5 wt. % of a perhydrolase (calculated on the total weight of the composition), in particular less than 0.1 wt. % of a perhydrolase, more in particular is substantially free from perhydrolases, even more in particular be free from perhydrolases.

The disinfecting composition may comprise less than 4.0 wt. % of a C3-C6 N-alkyl-gamma-butyrolactam, in particular less than 3.0 wt. % (calculated on the total weight of the composition), more in particular less than 2.0 wt. %, more in particular less than 1.0 wt. %, more in particular less than 0.1 wt. %, more in particular less than 0.04 wt. %, more in particular be substantially free from C3-C6 N-alkyl-gamma-butyrolactam. As used herein, a “C3-C6 N-alkyl-gamma-butyrolactam” is a gamma-butyrolactam group—that is, a five-membered lactam group—substituted at nitrogen, wherein the nitrogen atom may be substituted with a branched or unbranched, saturated or unsaturated, substituted or unsubstituted C(3-6)alkyl chain. An example of a C3-C6 N-alkyl-gamma-butyrolactam is TamiSolve® NxG (Eastman Chemical Company).

The disinfecting composition may comprise less than 15 wt. % of C(1-6)alkylalcohol, in particular ethanol (calculated on the total weight of the composition). It is preferred for the disinfecting composition to comprise less than 10 wt. % of C(1-6)alkylalcohol (in particular, of ethanol), in particular less than 5.0 wt. % of C(1-6)alkylalcohol (in particular, of ethanol). The composition may comprise less than 2.0 wt. % C(1-6)alkylalcohol (e.g. ethanol), or be substantially free of C(1-6)alkylalcohol (e.g. ethanol), or free of C(1-6)alkylalcohol (e.g. ethanol). A disadvantage of C(1-6)alkylalcohols is that they are flammable at room-temperature at levels exceeding 20-25 wt. %. Additionally, at least some of them have potential for causing eye irritation. More specifically, n-propanol is classified as causing serious eye damage with in class H318 in the Globally Harmonized Hazard Classification System (GHS), while isopropyl alcohol and ethanol are both classified as causing serious eye irritation in class H319. Due to their high volatility, C(1-6)alkylalcohols may cause fumes which are detrimental to the user's respiratory tract. In addition to the above safety aspects, C(1-6)alkylalcohols have an adverse effect on many surfaces (such as linoleum, plastic composites, PVC, PMMA, rubbers, glues, painted surfaces, etc.), making their use as hard-surface cleaner not attractive.

It will be clear to the skilled person that combinations of the above-mentioned embodiments are envisaged. For example, the disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more compounds according to formula II, (O═)P(R²)(R³)(—O—(CH(R⁵)—CH₂—O)ₙ—R⁶) or a salt thereof, wherein: R² is H or OH; R³ is OH; R⁵ is H or CH₃, n is 4-6; and R⁶ is an alkyl radical containing 4-18 carbon atoms, in a total amount of from 0.1 to 10 wt. % (as calculated on the total weight of the composition);
d) from 0.01 to 2.0 wt. % of a hydrogen peroxide stabilizer (calculated on the total weight of the composition);
e) one or more acids in a total amount of from 0.1 to 2.0 wt. % (calculated on the total weight of the composition); and
wherein the disinfecting composition has a pH of from 1.5 to 3.0, and optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more compounds according to formula III, R⁷—O—(CH(R⁸)—CH₂—O)ₛ—CH₂—COOH or a salt thereof, wherein R⁷ is a C(6-12)alkyl or a C(6-12)alkenyl, R⁸ is H or CH₃, and s is 3-10, in a total amount of from 0.1 to 10 wt. % (as calculated on the total weight of the composition);
d) from 0.01 to 2.0 wt. % of a hydrogen peroxide stabilizer (calculated on the total weight of the composition);
e) one or more acids in a total amount of from 0.1 to 2.0 wt. % (calculated on the total weight of the composition); and
wherein the disinfecting composition has a pH of from 1.5 to 3.0,
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more compounds according to formula II, (O═)P(R²)(R³)(—O—(CH(R⁵)—CH₂—O)ₙ—R⁶) or a salt thereof, wherein: R² is H or OH; R³ is OH; R⁵ is H or CH₃, n is 4-6; and R⁶ is an alkyl radical containing 4-18 carbon atoms, in a total amount of from 0.1 to 10 wt. % (as calculated on the total weight of the composition);
d) one or more anionic surfactants in a total amount of from 0.2 to 5.0 wt. % of an anionic surfactant (calculated on the total weight of the composition),
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0, and
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more compounds according to formula III, R⁷—O—(CH(R⁸)—CH₂—O)ₛ—CH₂—COOH or a salt thereof, wherein R⁷ is a C(6-12)alkyl or a C(6-12)alkenyl, R⁸ is H or CH₃, and s is 3-10, in a total amount of from 0.1 to 10 wt. % (as calculated on the total weight of the composition);
d) one or more anionic surfactants in a total amount of from 0.2 to 5.0 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0,
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more compounds according to formula II, (O═)P(R²)(R³)(—O—(CH(R⁵)—CH₂—O)ₙ—R⁶) or a salt thereof, wherein: R² is H or OH; R³ is OH; R⁵ is H or CH₃, n is 4-6; and R⁶ is an alkyl radical containing 4-18 carbon atoms, in a total amount of from 0.1 to 10 wt. % (as calculated on the total weight of the composition);
d) optionally, one or more anionic surfactants in a total amount of from 0.2 to 5.0 wt. % (calculated on the total weight of the composition)
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0, and
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more compounds according to formula III, R⁷—O—(CH(R⁸)—CH₂—O)ₛ—CH₂—COOH or a salt thereof, wherein R⁷ is a C(6-12)alkyl or a C(6-12)alkenyl, R⁸ is H or CH₃, and s is 3-10, in a total amount of from 0.1 to 10 wt. % (as calculated on the total weight of the composition);
d) optionally, one or more anionic surfactants in a total amount of from 0.2 to 5.0 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0,
optionally wherein the disinfecting composition comprises less than 3.0 wt. % of benzyl alcohol (calculated on the total weight of the composition),
in particular wherein the disinfecting composition comprises less than 0.75 wt. % of

N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester, C(3-5)alkyl substituted with one hydroxyl group and one methyl ester,
   C(3-5)alkyl substituted with one or two hydroxyl groups, or
   C(3-5)alkyl substituted with one or two methyl esters, and/or
one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more compounds according to formula II, (O═)P(R²)(R³)(—O—(CH(R⁵)—CH₂—O)ₙ—R⁶) or a salt thereof, wherein: R² is H or OH; R³ is OH; R⁵ is H or CH₃, n is 4-6; and R⁶ is an alkyl radical containing 4-18 carbon atoms, in a total amount of from 0.1 to 10 wt. % (as calculated on the total weight of the composition);
d) from 0.01 to 2.0 wt. % of a hydrogen peroxide stabilizer (calculated on the total weight of the composition);
e) one or more acids in a total amount of from 0.1 to 2.0 wt. % (calculated on the total weight of the composition); and
wherein the disinfecting composition has a pH of from 1.5 to 3.0, and
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester, C(3-5)alkyl substituted with one hydroxyl group and one methyl ester,
   C(3-5)alkyl substituted with one or two hydroxyl groups, or
   C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more compounds according to formula III, R⁷—O—(CH(R⁸)—CH₂—O)ₛ—CH₂—COOH or a salt thereof, wherein R⁷ is a C(6-12)alkyl or a C(6-12)alkenyl, R⁸ is H or CH₃, and s is 3-10, in a total amount of from 0.1 to 10 wt. % (as calculated on the total weight of the composition);
d) from 0.01 to 2.0 wt. % of a hydrogen peroxide stabilizer (calculated on the total weight of the composition);
e) one or more acids in a total amount of from 0.1 to 2.0 wt. % (calculated on the total weight of the composition); and
wherein the disinfecting composition has a pH of from 1.5 to 3.0,
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester, C(3-5)alkyl substituted with one hydroxyl group and one methyl ester,
   C(3-5)alkyl substituted with one or two hydroxyl groups, or
   C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more compounds according to formula II, (O═)P(R²)(R³)(—O—(CH(R⁵)—CH₂—O)ₙ—R⁶) or a salt thereof, wherein: R² is H or OH; R³ is OH; R⁵ is H or CH₃, n is 4-6; and R⁶ is an alkyl radical containing 4-18 carbon atoms, in a total amount of from 0.1 to 10 wt. % (as calculated on the total weight of the composition);
d) one or more anionic surfactants in a total amount of from 0.2 to 5.0 wt. % of an anionic surfactant (calculated on the total weight of the composition),
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0, and
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
C(1-3)alkoxy-C(2-3)alkoxy-C(2-3)alkyl wherein the C(1-3)alkoxy is optionally substituted with one hydroxyl group or methyl ester,
C(2)alkyl substituted with one hydroxyl group or one methyl ester, C(3-5)alkyl substituted with one hydroxyl group and one methyl ester,
C(3-5)alkyl substituted with one or two hydroxyl groups, or
C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more compounds according to formula III, R⁷—O—(CH(R⁸)—CH₂—O)ₛ—CH₂—COOH or a salt thereof, wherein R⁷ is a C(6-12)alkyl or a C(6-12)alkenyl, R⁸ is H or CH₃, and s is 3-10, in a total amount of from 0.1 to 10 wt. % (as calculated on the total weight of the composition);
d) one or more anionic surfactants in a total amount of from 0.2 to 5.0 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0,
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester, C(3-5)alkyl substituted with one hydroxyl group and one methyl ester,
   C(3-5)alkyl substituted with one or two hydroxyl groups, or
   C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more compounds according to formula II, (O═)P(R²)(R³)(—O—(CH(R⁵)—CH₂—O)ₙ—R⁶) or a salt thereof, wherein: R² is H or OH; R³ is OH; R⁵ is H or CH₃, n is 4-6; and R⁶ is an alkyl radical containing 4-18 carbon atoms, in a total amount of from 0.1 to 10 wt. % (as calculated on the total weight of the composition);
d) optionally, one or more anionic surfactants in a total amount of from 0.2 to 5.0 wt. % (calculated on the total weight of the composition)
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0, and optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester, C(3-5)alkyl substituted with one hydroxyl group and one methyl ester,
   C(3-5)alkyl substituted with one or two hydroxyl groups, or
   C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more compounds according to formula III, R⁷—O—(CH(R⁸)—CH₂—O)ₛ—CH₂—COOH or a salt thereof, wherein R⁷ is a C(6-12)alkyl or a C(6-12)alkenyl, R⁸ is H or CH₃, and s is 3-10, in a total amount of from 0.1 to 10 wt. % (as calculated on the total weight of the composition);
d) optionally, one or more anionic surfactants in a total amount of from 0.2 to 5.0 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0,
optionally wherein the disinfecting composition comprises less than 3.0 wt. % of benzyl alcohol (calculated on the total weight of the composition),
in particular wherein the disinfecting composition comprises less than 0.75 wt. % of N,N-dimethyldecylamine N-oxide (calculated on the total weight of the composition), more in particular wherein the disinfecting composition comprises less than 0.1 wt. % (calculated on the total weight of the composition) of an amide oxide surfactant according to the formula R¹⁰R¹¹R¹²N⁺O⁻, wherein R¹⁰ contains 8-18 carbon atoms and R¹¹ and R¹² each contain 1-4 carbon atoms.

### Applications of the Disinfecting Composition

The disinfecting composition according to the disclosure is surprisingly effective against bacteria (e.g., Staphylococcus aureus, Salmonella typhimurium, Pseudomonas aeruginosa, Escherichia coli), fungi (e.g., Candida auris) and viruses (e.g., Norovirus, Feline Calicivirus). Accordingly, it may find use in both medical and non-medical applications. The disinfecting composition is particularly effective in killing bacteria, fungi and viruses on hard and soft innate surfaces, with short contact times.

The disinfecting composition of the disclosure are particularly effective to be used in a preimpregnated towelette to disinfect hard surfaces with short contact times.

Furthermore, the disinfecting composition may further be used in treating a skin infection. In particular, the disinfecting composition according to the disclosure may be for treating a skin infection caused by bacteria or fungi, such as Staphylococcus aureus, Candida auris, Salmonella typhi, Pseudomonas aeruginosa, or Escherichia coli, more in particular Staphylococcus aureus or Candida auris.

Also disclosed herein is a method of disinfecting a surface comprising applying the disinfecting composition according to the disclosure to the surface. The surface may be a metal surface, a lacquered surface, a veneered surface, a painted surface, a glass surface, or plastic surface, such as the surfaces of tabletops, doorknobs, floors, doors, television remote controls, computer keyboards and other frequently touched objects that may participate in germ transmission. The surface may, in particular, comprise (or be made of) a material selected from the group of poly(methyl methacrylate) (PMMA), high or low density polyethylene (HDPE or LDPE), acrylonitrile butadiene styrene (ABS), acrylic polyvinyl chloride, polypropylene (PP), polycarbonate (PC), polyethylene terephthalate (PETG), and stainless steel. The method of disinfecting a surface may be a non-therapeutic method.

The method of disinfecting a surface may comprise applying the disinfecting composition to the surface with a towelette comprising the disinfecting composition. The disinfecting composition may be applied for a period of from 30 seconds to 10 minutes, in particular for a period of from 40 seconds to 3 minutes, more in particular for a period of from 50 seconds to 1.5 minutes.

The disinfecting composition according to the disclosure is surprisingly suitable for application with a preimpregnated towelette. Accordingly, the disinfecting composition may be included within a towelette. Thus, disclosed herein is also a towelette comprising the disinfecting composition according to the disclosure. A towelette may consist of a sheet-like substrate impregnated with a liquid composition, in the present case the disinfecting composition according to the disclosure.

Suitable substrates for towelettes are well-known in the art and include woven and non-woven sheets of a fibrous material with sufficient wet strength and liquid absorption capacity to contain a suitable amount of the liquid composition according to the invention and deliver it to the surface to be cleaned. The fibres in the fibrous material may be from natural sources e.g. viscose or cellulose such as wood pulp or cotton, or cellulose fibres from paper, bamboo, wheatgrass, carton, etc. or synthetic origin such as polypropylene (PP), polyethylene (PE), or polyethyleneterephthalate (PET). Combinations of materials may also be used. Optionally, the substrate may comprise one or more polymeric binders. Any binder material present should not be soluble in the liquid composition to such an extent that it causes the towelette to cause streaking on the cleaned surface. The substrate can be manufactured by methods known in the art which require no elucidation here.

The towelette may be a single layer structure or a multilayer structure, wherein the layers may be the same or different. In one embodiment, prior to impregnation with the composition described herein, the towelette has an average thickness ranging from 0.1 to 3.0 mm, preferably from 0.2 to 1.0 mm, more preferably from 0.3 to 0.6 mm. Prior to impregnation with the composition of the invention, the towelette typically has a base weight of from 20 to 100 g/m², preferably from 30 to 90 g/m², more preferably from 40 to 80 g/m². The composition described herein is impregnated in a ratio of typically between 200% and 500% of liquid weight to the weight of the towelette substrate, preferably 220%-450%, depending on the material of the towelette.

The composition can also be applied by spraying and/or flooding the surface with the disinfectant composition or by immersion of (e.g., medical) items in the use solution. However, the preferred method of application is to use the composition in an impregnated towelette, as disclosed above. Towelettes are used to clean a surface though light rubbing or friction. One of the main benefits that towelettes provide is convenience-using a towelette is quicker and easier than the alternative of dispensing a liquid and using another cloth/paper towel to clean or remove the liquid.

As will be evident to the skilled person, different embodiments of the present invention can be combined unless they are mutually exclusive.

The present disclosure also contemplates the possibility of omitting any of components listed herein. The present disclosure further contemplates the omission of any components even though they are not expressly named as included or excluded from the disclosure. For example, the present disinfecting compositions can be substantially free of compounds or ingredients not expressly recited. As used herein, a disinfecting composition that is “substantially free of” one or more ingredients means that the disinfecting composition includes no more than trace or incidental amounts of those ingredients. Trace or incidental amounts of an ingredient can be found in another ingredient as an impurity or as a by-product of a side reaction during formation or degradation of a component of the composition. For the sake of clarity, ingredients present in a trace or incidental amount will not be present in excess of 0.5 wt. % based on the total weight of the composition, in particular not in excess of 0.3 wt. %, more in particular not in excess of 0.1 wt. %, more in particular not in excess of 0.01 wt. %.

### Definitions, Etc

As used herein, “C(x)alkyl” refers to an alkyl group having x carbon atoms in a linear or branched arrangement. For example, the term “C(6)alkyl” refers to a hexyl group.

As used herein, “C(x-y)alkyl” refers to an alkyl group having x to y carbon atoms in a linear or branched arrangement. For example, the term “C(1-5)alkyl” refers to an alkyl having 1 to 5 carbon atoms, i.e. to methyl, ethyl, propyl, butyl, and pentyl groups. As another example, the term “C(6-16)alkyl” refers to an alkyl group having 6 to 16 carbon atoms, so to hexyl, heptyl, octyl, nonyl, decyl, undecyl, dodecyl, tridecyl, tetradecyl, pentadecyl, and hexadecyl groups.

As used herein, “C(x-y)alkenyl” refers to an alkenyl group having x to y carbon atoms in a linear or branched arrangement. For example, the term “C(2-3)alkenyl” refers to an alkenyl group having 2 or 3 carbon atoms, i.e. to ethenyl, 1-propenyl, or 2-propenyl groups.

As used herein, “C(x)alkoxy” refers an alkyl group having x carbon atoms attached through an oxygen linking atom. For example, “C(1)alkoxy” refers to an alkyl group having 1 carbon atoms (i.e., methyl) attached through an oxygen linking atom, so to a methoxy group.

As used herein, “C(x-y)alkoxy” refers an alkyl group having x to y carbon atoms attached through an oxygen linking atom. For example, “C(1-3)alkoxy” refers to an alkyl group having one to three carbon atoms (i.e., methyl, ethyl, (iso-) propyl) attached through an oxygen linking atom, so to a methoxy, ethoxy or (iso-) propoxy group.

As used herein, “C(x₁-y₁)alkoxy-C(x₂-y₂)alkyl” refers to a “C(x₁-y₁)alkoxy” group attached to a C(x₂-y₂)alkyl group, both with the same meaning as previously defined. The number of carbon atoms of the C(x-y)alkoxy group and the C(x-y)alkyl group are independent. For example, the term “C(1-5)alkoxy-C(1-5)alkyl” refers to a C(1-5)alkoxy group attached to a C(1-5)alkyl group.

As used herein, “C(x₁-y₁)alkoxy-C(x₂-y₂)alkoxy-C(x₃-y₃)alkyl” refers to a “C(x₁-y₁)alkoxy” group attached to a “C(x₂-y₂)alkoxy” group, which is attached to a C(x₃-y₃)alkyl group, all with the same meaning as previously defined. The number of carbon atoms of the C(x-y)alkoxy groups and the C(x-y)alkyl group are independent. For example, the term “C(1-3)alkoxy-C(1-5)alkoxy-C(1-5)alkyl” refers to a C(1-3)alkoxy group attached to a C(1-5)alkoxy group, which is attached to a C(1-5)alkyl group.

As used herein, “C(x-y)alkylalcohol” refers to alkyl groups having x to y carbon atoms substituted with one hydroxyl groups. For example, “C(2-3) alcohol” can refer to ethanol, propanol, vinylalcohol, and allylalcohol.

As used herein, “C(x-y)alkenyl” refers to an alkenyl group having x to y carbon atoms. For example, “C(2-3)alkenyl” can refer to ethenyl, 1-propenyl and 2-propenyl groups.

As used herein, “C(x-y)alkynyl” refers to an alkynyl group having x to y carbon atoms. For example, “C(2-3)alkenyl” can refer to ethylyl, 1-propynyl and 2-propynyl.

As used herein, “C(x)aryl” refers to an aryl group having x carbon atoms. For example, “C(6)aryl” refers to phenyl.

As used herein, “C(4-5)heteroaryl” refers to an heteroaryl group having 4 or 5 carbon atoms and 2 or 1 heteroatoms, respectively. The heteroatom is preferably a nitrogen atom. Examples include pyridinyl, pyrimidinyl, and pyrazinyl.

As used herein, “C(x-y)cycloalkyl” refers to a saturated or partially unsaturated cycloalkyl group having x to y carbon atoms. For example, “C(5-8) cycloalkyl” can refer to cyclopentyl, cyclohexyl, cycloheptyl, cyclooctyl, and cyclooctenyl.

As used herein, “C(x₁)aryl-C(x₂-y₂)alkyl” refers to an aryl group having x₁ carbon atoms, which is attached to an alkyl group having x₂ to y₂ carbon atoms. For example “C(6)aryl-C(1-2)alkyl” refers to a phenyl group, which is attached to a methyl group or an ethyl group.

As used herein, “C(x₁-y₁)heteroaryl-C(x₂-y₂)alkyl” refers to refers to an heteroaryl group having 4 or 5 carbon atoms and 2 or 1 heteroatoms, respectively, which is attached to an alkyl group having x₂ to y₂ carbon atoms. For example “C(4-5)heteroaryl-C(1-2)alkyl” can refer to a pyridinyl, pyrimidinyl, or pyrazinyl group, which is attached to a methyl group or an ethyl group.

All percentages used herein are weight percentages, unless specified otherwise. In addition, unless specified otherwise, the weight percentages are calculated using the net weight of a particular component and the total weight of the disinfecting composition.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

### EXAMPLES

The following examples will illustrate the practice of the present invention in some of the preferred embodiments. Other embodiments within the scope of the claims will be apparent to one skilled in the art.

### Example 1: Antimicrobial Activity of the Disinfecting Compositions Comprising a Compound According to Formula II

To test bactericidal efficacy, a towelette test was performed following to the Germicidal Towelette Method/AOAC Official Method 961.02, which is a modification of the AOAC Germicidal Spray Products as Disinfectants Test 961.02 for pre-saturated towelettes. The test evaluates the effectiveness of towelette products as disinfectants for contaminated surfaces and meets the requirements of the EPA OCSPP 8102000 and 810.2200 Product Performance Test Guidelines (February 2018), and Health Canada's “Guidance Document—Safety and Efficacy Requirements for Surface Disinfectant Drugs” (April 2020) and “Guidance Document—Disinfectant Drugs” (April 2020).

Briefly, glass microscope slides as carriers were sterilized prior to use. The carriers were then inoculated with approximately 10⁵ colony forming units (CFU) per carrier of Staphylococcus aureus (S. aureus) as indicated, by spreading a culture of the respective bacterium over the surface of the carrier. The carriers were allowed to dry. Then, each carrier was wiped at room temperature with a towelette impregnated with a test composition as indicated in Tables 1 or 2. The towelette was held in contact with the carrier for the time indicated in the Tables. Per test composition, 60 replicates were performed using one lot of each test composition. After wiping, the carrier was transferred to a neutralizing recovery medium, incubated for 48 hours at 37° C. in broth and observed for visible bacterial growth. Controls as described in AOAC Official Method 961.02 were also included. Absence of microbial growth or turbidity in the broth in substantially all replicates (preferably in 57 or more replicates, more preferably in 59 or 60 replicates) was considered a “pass” of the test.

For efficacy against Candida auris, the OECD “Quantitative Method for Evaluating Efficacy of Liquid Antimicrobials against Candida auris on Hard, Non-Porous Surfaces” is used.

In this method, a series of stainless steel disks are inoculated with test organism. In case of towelettes, the disinfecting composition is expressed from the wipe and tested. The carriers are desiccated and subsequently treated with a sample of the liquid disinfectant for a certain exposure time. After exposure, the carriers are neutralized and quantitatively assayed for surviving test organism. The resulting plates are incubated, the number of survivors is enumerated and a Log 10 reduction is determined as compared to the population control.

Two batches of the product are tested, one batch per day, using separate test cultures. For each batch, evaluate five carriers against the product and three untreated control carriers. Each of the three control carriers should preferably exhibit C. auris counts of a minimum of 1.0×10⁵ to a maximum of 1.0×10⁶ colony forming units (CFUs) per carrier. A log reduction of >5 is considered a “pass” of the test.

To test virucidal efficacy, a test following the procedure outlined in the ASTM International test method designated E1053-20, “Standard Practice to Assess Virucidal Activity of Chemicals Intended for Disinfection of Inanimate, Nonporous Environmental Surfaces”, was performed. This test is designed to simulate consumer use and determines the potential of the test substance to disinfect hard surfaces contaminated with the test virus. The test conforms to EPA OCSPP 810.2000 (2018) and 810.2200 (2018) Product Performance Test Guidelines, OCSPP 8102000, 810.2100 and 810.2200, and to Health Canada's “Guidance Document—Safety and Efficacy Requirements for Surface Disinfectant Drugs” (April 2020) and “Guidance Document—Disinfectant Drugs” (April 2020).

Briefly, Feline Calicivirus (FCV) is dried on sterile glass Petri dishes as carriers at room temperature. A 10 square inch surface area of each carrier was wiped with a towelette impregnated with a disinfecting composition as indicated in Table 1. The towelette was held in contact with the carrier for 50 seconds. After wiping, the bottom of the carrier is scraped to resuspend the virus. The resuspended virus is passed through a gel filtration column for neutralization. The log reduction of the feline calicivirus titer was determined as described in ASTM E1053-20. A log reduction of the feline calicivirus titer of >3 is indicative of a total kill. Controls as described in ASTM E1053-20 were also included.

Disinfecting compositions were prepared using, amongst others, the ingredients as described the table below.

| Ingredient name | Description |
|---|---|
| Monafax 1214 | Aliphatic phosphate ester (C8-10 and 4 EO) |
| Akypo LF2 | Capryleth-9 carboxylic acid (C8 and 8 EO) |
| Akypo LF4 | Aliphatic ethercarboxylic acid (C6-8 and 4-9 EO) |
| | (70% capryleth-9 carboxylic acid and 15% Hexeth-4 |
| | carboxylic acid) |
| Akypo LF6 | Aliphatic ethercarboxylic acid (C4-8 and 4-9 EO) |
| | (mixture of capryleth-9 carboxylic acid and buteth-2 |
| | carboxylic acid) |
| AG6206 | Alkyl glucoside based on a short-chain (C6) fatty |
| | alcohol and glucose |
| Baypure CX100 | Tetrasodium iminodisuccinate |
| Interox CO-35 | Hydrogen peroxide, 35% active |
| Dowanol PMA | Propylene glycol methyl ether acetate |
| Dowanol TPM | Tripropylene glycol methyl ether |
| Dowanol DPMA | Dipropylene glycol methyl ether acetate |
| Dowanol PnB | Propylene glycol n-butyl ether |
| Dowanol PGDA | Propylene glycol diacetate |
| Triacetin | Glycerol triacetate |
| Lutensol XL80 | C10 alcohol ethoxylate |
| | (C10-guerbet alcohol alkoxylates, 8EO) |
| Glucopon 215 | Alkyl glucoside based on a short-chain (C8) fatty |
| | alcohol and glucose |
| Triton CG-110 | Alkyl polyglucoside |
| Mackamine 654 | N,N-Dimethyldecylamine N-oxide |
| Dequest 2010 LC | (1-Hydroxy-1-phosponoethyl)phosphonic acid |
| Protelan AG 8 | Sodium capryloyl glutamate |
| Tego Betaine F50 | Cocoamidopropyl betaine |
| Zetesol Zn | Zinc coceth sulphate |

In the Tables below, the weight percentages of each active are calculated using the net weight of a particular component and the total weight of the disinfecting composition.

Table 1 discloses the activity of disinfecting compositions according to the disclosure against FCV and C. auris:

TABLE 1
Antimicrobial activity of disinfecting compositions comprising
a compound according to formula II against FCV and C. auris.

| Sample no.: | 1 | 2 | 3 | 4 | 5 | 6 | 7 | 8 | 9 | 10 |
|---|---|---|---|---|---|---|---|---|---|---|
| Water | 91.44 | 91.44 | 90.24 | 91.24 | 91.13 | 90.24 | 90.24 | 90.24 | 90.44 | 91.44 |
| Monafax 1214 | 0.95 | 0.95 | 0.95 | 0.95 | 1.14 | 0.95 | 0.95 | 0.95 | 0.95 | 0.95 |
| Phosphoric acid | 0.50 | 0.50 | 0.50 | 0.50 | 0.50 | 0.50 | 0.50 | 0.50 | 0.50 | 0.50 |
| AG6206 | 0.08 | 0.08 | 0.08 | 0.08 | — | 0.08 | 0.08 | 0.08 | 0.08 | 0.08 |
| Baypure CX100 | 0.02 | 0.02 | 0.02 | 0.02 | 0.02 | 0.02 | 0.02 | 0.02 | 0.02 | 0.02 |
| Interox CO-35 | 1.00 | 1.00 | 1.00 | 1.00 | 1.00 | 1.00 | 1.00 | 1.00 | 1.00 | 0.30 |
| Dowanol PMA | — | — | 2.00 | 1.00 | 2.00 | 2.00 | 3.00 | 2.00 | — | 3.00 |
| Triacetin | 3.00 | — | — | — | — | 1.00 | 1.00 | 1.00 | — | — |
| Dowanol PGDA | — | 3.00 | 2.00 | 3.00 | 2.00 | 2.00 | — | 1.00 | — | — |
| Dowanol TPM | 1.00 | 1.00 | 1.00 | — | — | — | 1.00 | 1.00 | 1.00 | 1.00 |
| Dowanol DPMA | — | — | — | — | — | — | — | — | 4.00 | — |
| Salicylic acid | 0.20 | 0.20 | 0.20 | 0.20 | 0.20 | 0.20 | 0.20 | 0.20 | 0.25 | 0.20 |
| NaOH (30%) | 0.45 | 0.45 | 0.45 | 0.45 | 0.45 | 0.45 | 0.45 | 0.45 | 0.45 | 0.45 |
| pH | 2.0 | 2.0 | 2.0 | 2.0 | 2.0 | 2.0 | 2.0 | 2.0 | 2.0 | 2.0 |
| Activity against FCV (log | >3 | >3 | >3 | >3 | >3 | >3 | >3 | >3 | >3 | >3 |
| reduction after 50 s contact | | | | | | | | | | |
| time) | | | | | | | | | | |
| Activity against C. auris (log | >5 | >5 | >5 | >5 | >5 | >5 | >5 | >5 | >5 | >5 |
| reduction after 50 s contact | | | | | | | | | | |
| time) | | | | | | | | | | |

The compositions in Table 1 generally contain a compound according to formula I (Dowanol PMA, triacetin, propylene glycol diacetate, and/or Dowanol DPMA), a compound according to formula IIa (Monafax), and hydrogen peroxide. Each of the disinfecting compositions evaluated resulted in a total kill of both FCV and C. auris after a contact time of just 50 seconds.

The efficacy of the disinfecting compositions against FCV is surprisingly higher than the efficacy against FCV of the compositions described in WO 2020/152245. Indeed, a longer contact time (of 2 minutes) was used in WO 2020/152245 and activities reported therein were generally lower than achieved with the disinfecting compositions according to the present disclosure.

It Is also surprising that the disinfecting compositions in Table 1 are so highly active against C. auris, as very few, if any, disinfecting compositions with low hydrogen peroxide levels in the art are reported to be active against C. auris.

To evaluate the antimicrobial activity of disinfecting compositions further, disinfecting compositions having different amounts of surfactants and having different pH values were prepared, and subjected to the tests described in Example 1 above. The results are disclosed in Table 2:

TABLE 2
Antimicrobial activity of disinfecting compositions comprising
a compound according to formula II against S. aureus.

| Sample no.: | 11 | 12 | 13 | 14* | 15* | 16* |
|---|---|---|---|---|---|---|
| Water | 90.85 | 90.29 | 87.18 | 91.40 | 91.52 | 91.52 |
| Monafax 1214 | 0.29 | 3.80 | 2.85 | 0.95 | 0.95 | 0.95 |
| Phosphoric acid | 0.41 | — | — | — | — | — |
| NaOH (30 wt. %) | — | 0.08 | 0.11 | 0.05 | 0.01 | 0.01 |
| AG 6206 | 0.15 | 0.15 | 0.15 | 0.15 | 0.15 | 0.15 |
| Interox CO-35 | 1.4 | 1.4 | 2.1 | 1.4 | 1.4 | 1.4 |
| Dowanol PMA | 2.0 | 0.50 | 2.0 | 2.0 | — | — |
| Triacetin | — | 0.50 | 1.0 | 1.0 | — | — |
| Dowanol PGDA | 2.0 | — | — | — | — | — |
| Dowanol TPM | — | — | — | — | — | 3.0 |
| Dowanol PnB | — | — | — | — | 3.0 | — |
| Sodium benzoate | 0.20 | 0.20 | 0.20 | 0.20 | 0.20 | 0.20 |
| pH | 2.0 | 2.0 | 3.0 | 4.0 | 2.5 | 2.5 |
| Activity against S. | 1/60 | 1/60 | 3/60 | 8/60 | 6/60 | 14/60 |
| aureus (50 s contact | | | | | | |
| time) | | | | | | |

*These samples are not according to the disclosure: comparative sample 14 has a pH of 4.0; and comparative samples 14-16 do not contain compounds according to formula I.

As can be derived from Table 2, good antimicrobial activity against S. aureus could be obtained using the disinfecting compositions according to the disclosure (samples 11-13). This indicates, together with the data disclosed in Table 1, that the disinfecting compositions according to the disclosure have antimicrobial activity against a broad spectrum of microorganisms.

When the pH was increased, the antimicrobial activity decreased (see, comparative sample 14). Surprisingly, the disinfecting compositions according to the disclosure were also (far) more active than compositions comprising just propylene glycol n-butyl ether (Dowanol PnB; sample 15) as solvent or just tripropylene glycol methyl ether (Dowanol TPM; sample 16) as solvent.

Without wishing to be bound by theory, it is believed the surprising antimicrobial activity is associated with the specific combination of compounds used in and features of the compositions according to the disclosure (in particular, the combination of the compound according to formula I, the compound according to formula II, the hydrogen peroxide, and the pH).

### Example 2: Antimicrobial Activity of Disinfecting Compositions Comprising a Compound According to Formula III

To evaluate the antimicrobial activity of disinfecting compositions further, disinfecting compositions comprising a compound according to formula III were prepared, and subjected to the tests described in Example 1 above. The results are disclosed in Table 3:

TABLE 3
Antimicrobial activity of disinfecting compositions comprising
a compound according to formula III against S. aureus

| Sample no.: | 17 | 18 | 19 |
|---|---|---|---|
| Water | 93.39 | 91.47 | 91.76 |
| Phosphoric acid | — | 0.59 | — |
| Methane sulfonic acid | 0.31 | — | 0.33 |
| AG 6206 | 0.15 | 0.15 | 0.15 |
| Interox CO-35 | 1.00 | 1.40 | 0.50 |
| Akypo LF2 | 0.92 | — | — |
| Akypo LF4 | — | 0.45 | — |
| Akypo LF6 | — | — | 1.80 |
| Dowanol PMA | 1.0 | 2.0 | — |
| Triacetin | — | 1.00 | 2.00 |
| Dowanol PGDA | 1.00 | — | — |
| Sodium benzoate | 0.20 | 0.20 | 0.20 |
| pH | 2.0 | 2.0 | 2.0 |
| Activity against S. aureus | 0/60 | 2/60 | 2/60 |
| (50 s contact time) | | | |

As can be derived from Table 3, compositions with compounds according to formula III also demonstrated particularly good antimicrobial activity against S. aureus when applied using a towelette.

### Example 3: Antimicrobial Activity of the Disinfecting Compositions Compared Vis-à-Vis the Antimicrobial Activity of Disinfectants Compositions Described in the Literature

Disinfecting compositions according to the disclosure were then compared with a specific compositions described in the literature. For this comparison, composition 3 in Example 2 of WO 2020/152245 was prepared and its antimicrobial activity was evaluated using the tests described in Example 1 above. The results are disclosed in Table 4:

TABLE 4
Antimicrobial activity vis-à-vis the antimicrobial
activity of a composition described in the literature

| Sample no.: | 20* | 21 |
|---|---|---|
| Water | 86.50 | 86.87 |
| Phosphoric acid | 1.72 | 1.35 |
| Triton CG-110 | 0.36 | 0.36 |
| Interox CO-35 | 0.50 | 0.50 |
| Akypo LF4 | 0.675 | 0.675 |
| Dowanol PnB | 6.00 | — |
| Mackamine 654 | 2.50 | 2.50 |
| Dequest 2010 LC | 0.20 | 0.20 |
| Dowanol PMA | — | 2.00 |
| Triacetin | — | 2.00 |
| Dowanol PGDA | — | 2.00 |
| Sodium benzoate | 0.10 | 0.10 |
| pH | 2.0 | 2.0 |
| Activity against S. aureus | 6/60 | 1/60 |
| (50 s contact time) | | |

*This sample is not according to the disclosure, as it did not contain compounds according to formula I.

Comparative sample 20 (corresponding to composition 3 in Example 2 of WO 2020/152245) failed to pass the towelette test set out in the Germicidal Towelette Method/AOAC Official Method 961.02, because six colonies of S. aureus grew after contacting with the composition for 50 seconds.

Surprisingly, replacing the solvent (Dowanol PnB) with a mixture of compounds according to formula I increased the antimicrobial activity (see, sample 21). Sample 21 did pass the towelette test set out in the Germicidal Towelette Method/AOAC Official Method 961.02, because just one colony managed to grow after contacting with sample 21 for 50 seconds. This unexpected increase in antimicrobial activity clearly demonstrates the remarkable effect of the presence of the compound according to formula I in the compositions according to the disclosure.

### Example 4: Antimicrobial Activity of Compositions Described in the Art

Compositions described in the art were made and their antimicrobial activity was determined as described in Example 1. The results are summarized in Table 4:

TABLE 5
Activity against S. aureus of compositions described in the art

| Sample no.: | 22* | 23* |
|---|---|---|
| Water | 87.27 | 96.03 |
| Monafax 1214 | 0.61 | 0.48 |
| Phosphoric acid | — | 0.06 |
| Lutensol XL80 | — | 0.60 |
| Acetanilide | — | 0.50 |
| Glucopon 215 | — | 0.065 |
| Baypure CX100 | — | 0.017 |
| Interox CO-35 | 2.50 | 0.50 |
| Protelan AG 8 | 0.72 | — |
| Tego Betaine F50 | 0.72 | — |
| Zetesol Zn | 0.25 | — |
| Disodium EDTA | 0.10 | — |
| pH | 4.2 | 4.5 |
| Activity against S. aureus | 59/60 | 60/60 |
| (60 s contact time) | | |

*These samples are not according to the disclosure; comparative samples 22 and 23 did at least not contain a compound according to formula I.

Comparative sample 22 essentially corresponds to composition 15 of WO 2008/071746 (with EDTA instead of OctaQuest (i.e., trisodium ethylenediamine succinate) as chelating agent). According to WO 2008/071746, this sample is effective against S. aureus in the EN 1276 test. However, the results in the above demonstrate that comparative sample 22 is not effective against S. aureus when applied using a towelette.

Comparative sample 23 corresponds to the solution of example 5 of WO 2007/080187. According to WO 2007/080187, the solution demonstrated antimicrobial activity against S. aureus in the EN 12054 test. However, the results in the above demonstrate that comparative sample 23 is not effective against S. aureus when applied using a towelette.

Together, the results demonstrate how difficult the towelette test according to the Germicidal Towelette Method/AOAC Official Method 961.02 is to pass. It is, therefore, surprising that the disinfecting composition compositions according to the disclosure do pass the towelette test.

### Example 5: Material Compatibility of the Disinfecting Compositions

The material compatibility of the disinfecting compositions was evaluated. The test used evaluates the compatibility of frequent exposure to the test compositions with various materials that frequently occur in healthcare environments. 5 cm×2 cm strips of polyurethane (PU), poly(methyl metacrylate) (PMMA; Perspex), high-density polyethylene (HDPE), low-density polyethylene (LDPE), acrylonitrile butadiene styrene (ABS), acrylic polyvinyl chloride (Kydex), polypropylene (PP), polycarbonate (PC), polyethylene terephthalate (PETG), aluminium, and stainless steel 316 were used as test material.

The test strips were weighted before immersion the strips were fully immersed in the disinfecting composition. The PMMA, aluminium, and stainless steel 316 strips were not fully immersed: only ±50% of the strip surface was below the liquid surface of the test composition, causing an air-liquid interface.

After 20 hours, the test composition was removed and the strips were allowed to air dry. After 4 hours of drying, the strips were put back in the test composition for a new 20 hour cycle. This cycle was repeated 4 times a week for 3 weeks. Every four cycles close-up pictures are taken, strips were weighted and observations were recorded. After the last cycle, the strips were cleaned with water and air dried. At the end of the test, the test strips were weighted again.

The disinfecting compositions according to the disclosure (in particular, samples 1-12 in Tables 1 and 2 above) were compatible with all materials tested, even when some peracetate was present in the compositions. For example, the PU rubber was not visibly affected by disinfecting compositions according to the disclosure. Only a minimal weight loss of around 4-6% was observed. The PMMA was also not visibly affected by samples 1-10 in Table 1.

The excellent material compatibility of the disinfecting compositions according to the disclosure is surprising, given that a comparative composition with good antimicrobial efficacy comprising a compound according to formula IIa, hydrogen peroxide, and benzyl alcohol as a solvent (Table 3) was found to be incompatible with many of the materials.

TABLE 6
Comparative composition for material compatibility test

| Sample no.: | 24* |
|---|---|
| Water | 91.22 |
| Monafax 1214 | 0.76 |
| Phosphoric acid | 0.55 |
| Glucopon 215 | 0.07 |
| Baypure CX100 | 0.02 |
| Interox CO-35 | 1.40 |
| Benzyl alcohol | 3.00 |
| Salicylic acid | 0.20 |
| pH | 2.5 |

*This comparative sample is not according to the disclosure, as it does not contain compounds according to formula I.

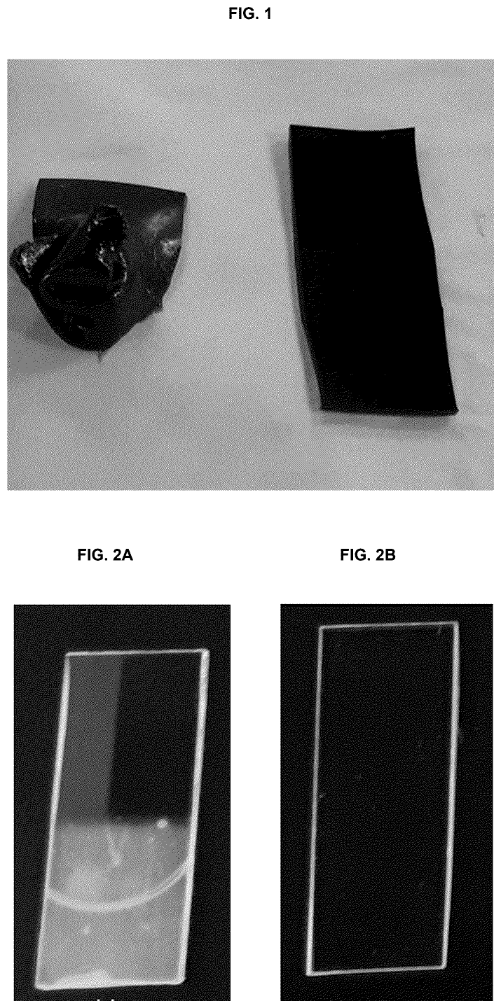

When this comparative composition (comparative sample 24) was evaluated, the PU rubber partially solubilized and the weight of the test strip decreased with 40-50%. Similarly, the comparative composition had a negative effect on PMMA. The PPMA test strip became soft and tacky, and its surface was completely destroyed. This is shown in FIGS. 1 to 2B.

FIG. 1 shows the effects of sample 3 and comparative sample 24 on a strip of polyurethane. The strip exposed to the disinfection composition of comparative sample 24 is depicted on the left, and is almost completely deformed. The strip exposed to sample 3 is depicted on the right, and shows little to no deformation.

FIGS. 2A and 2B show the effects of sample 3 and comparative sample 24 on a strip of PPMA. The strip exposed to the disinfection composition of comparative sample 24 is depicted on the left, and the part that was exposed to the disinfection composition (depicted in FIG. 2A) was soft, tacky, and damaged. The strip exposed to sample 3 (depicted in FIG. 2B) was still stiff, not tacky and showed no signs of damage.

### Example 7: Stability of the Disinfectant Compositions

The stability of the above mentioned disinfectant compositions according to the disclosure was evaluated using olfactory methods and is further evaluated with analytical techniques, including gas chromatography and photometric methods.

As an example, when composition 8 and 10 were evaluated 72 hours after they were made, no changes in composition were observed. In particular, no reaction between the compound(s) according to formula (I) and hydrogen peroxide was observed. Accordingly, the samples according to the disclosure are stable for at least 72 hours.

1. Disinfecting composition comprising:
a) one or more compounds according to formula I: 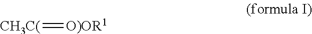
wherein R¹ is
C(1-5)alkoxy-C(1-5)alkyl wherein the C(1-5)alkoxy is optionally substituted with one hydroxyl group or methyl ester,
C(1-3)alkoxy-C(1-5)alkoxy-C(1-5)alkyl wherein the C(1-3)alkoxy is optionally substituted with one hydroxyl group or methyl ester,
C(2-5)alkyl wherein the C(2-5)alkyl is substituted with one or two methyl esters and/or one or two hydroxyl groups,
C(2-12)alkyl,
C(2-12)alkenyl,
C(2-12)alkynyl,
C(6)aryl-C(1-2)alkyl optionally substituted with one or more hydroxy, methoxy, amino, or C(1-3)alkyl groups,
and/or one or more compounds according to formula Ia: 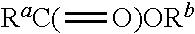
wherein R^{a} is C(6)aryl optionally substituted with hydroxyl, and R^{b} is a C(1-6)alkyl or C(6)aryl-(C1-2)alkyl,
wherein R^{a} is C(6)aryl-C(1-2)alkyl and R^{b} is C(6)aryl optionally substituted with methyl or C(1-6)alkyl optionally substituted with C(6)aryl,
wherein R^{a} is C(4-5)heteroaryl-C(1-2)alkyl and R^{b} is C(1-2)alkyl, or
wherein R^{a} is C(2-3)alkyl and R^{b} is C(6)aryl-C(1-2)alkyl optionally substituted with one or more hydroxy or methoxy,
in a total amount of from 0.1 to 20 wt. % (calculated on the total weight of the composition);
b) from 0.1 to 15 wt. % of hydrogen peroxide (calculated as the net weight of hydrogen peroxide on the total weight of the composition);
c) one or more compounds according to formula II: 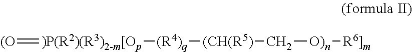
or a salt thereof,
wherein: R² is H or OH; R³ is OH; each R⁴ is independently an alkylene radical containing 1-18 carbon atoms and each R⁶ is independently H or an alkyl radical containing 1-18 carbon atoms, with the proviso that R⁴+R⁶≤20 total carbon atoms; each R⁵ is independently H or CH₃; m is 1 or 2; each n is independently 2-10; and each p and q is independently 0 or 1 with the proviso that when p is 0, q is 1,
and/or according to formula III: 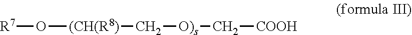
or a salt thereof,
wherein R⁷ is C(6-12)alkyl or C(6-12)alkenyl, R⁸ is H or CH₃, and s is 3-10, in a total amount of from 0.1 to 10 wt. % (calculated on the total weight of the composition); and
wherein the disinfecting composition has a pH of from 0.5 to 3.5.

2. The disinfecting composition according to claim 1, wherein the disinfecting composition comprises:
a) one or more compounds according to formula I: 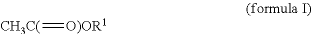
wherein R¹ is
C(1-5)alkoxy-C(1-5)alkyl wherein the C(1-5)alkoxy is optionally substituted with one hydroxyl group or methyl ester,
C(1-3)alkoxy-C(1-5)alkoxy-C(1-5)alkyl wherein the C(1-3)alkoxy is optionally substituted with one hydroxyl group or methyl ester,
C(2-5)alkyl wherein the C(2-5)alkyl is substituted with one or two methyl esters and/or one or two hydroxyl groups, or
C(2-5)alkyl,
in a total amount of from 0.1 to 20 wt. % (calculated on the total weight of the composition);
b) from 0.1 to 15 wt. % of hydrogen peroxide (calculated as the net weight of hydrogen peroxide on the total weight of the composition);
c) one or more compounds according to formula II: 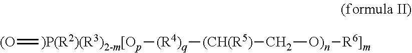
or a salt thereof,
wherein: R² is H or OH; R³ is OH; each R⁴ is independently an alkylene radical containing 1-18 carbon atoms and each R⁶ is independently H or C(1-18)alkyl, with the proviso that R⁴+R⁶≤20 total carbon atoms; each R⁵ is independently H or CH₃; m is 1 or 2; each n is independently 2-10; and each p and q is independently 0 or 1 with the proviso that when p is 0, q is 1,
and/or according to formula III: 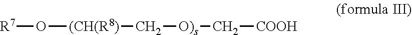
or a salt thereof,
wherein R⁷ is a C(6-12)alkyl or a C(6-12)alkenyl, R⁸ is H or CH₃, and s is 3-10,
in a total amount of from 0.1 to 10 wt. % (as calculated on the total weight of the composition); and
wherein the disinfecting composition has a pH of from 0.5 to 3.5.

3. The disinfecting composition according to claim 1, wherein R¹ is
C(1-5)alkoxy-C(2-3)alkyl wherein the C(1-5)alkoxy is optionally substituted with one hydroxyl group or methyl ester,
C(1-3)alkoxy-C(2-3)alkoxy-C(2-3)alkyl wherein the C(1-3)alkoxy is optionally substituted with one hydroxyl group or methyl ester,
C(2)alkyl substituted with one hydroxyl group or one methyl ester, C(3-5)alkyl substituted with one hydroxyl group and one methyl ester,
C(3-5)alkyl substituted with one or two hydroxyl groups, or
C(3-5)alkyl substituted with one or two methyl esters,
wherein the one or more compounds according to formula I are is selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, isoamylacetate, propylacetate, butylacetate, and pentylacetate.

4. The disinfecting composition according to claim 1, wherein the composition further comprises the one or more compounds according to formula Ia.

5. The disinfecting composition according to claim 1, wherein the disinfecting composition comprises:
a) one or more compounds according to formula Ia: 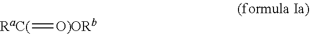
wherein R^{a} is C(6)aryl optionally substituted with hydroxyl, and R^{b} is a C(1-6)alkyl or C(6)aryl-(C1-2)alkyl,
wherein R^{a} is C(6)aryl-C(1-2)alkyl and R^{b} is C(6)aryl optionally substituted with methyl or C(1-6)alkyl optionally substituted with C(6)aryl,
wherein R^{a} is C(4-5)heteroaryl-C(1-2)alkyl and R^{b} is C(1-2)alkyl, or
wherein R^{a} is C(2-3)alkyl and R^{b} is C(6)aryl-C(1-2)alkyl optionally substituted with one or more hydroxy or methoxy,
in a total amount of from 0.1 to 20 wt. % (calculated on the total weight of the composition);
b) from 0.1 to 15 wt. % of hydrogen peroxide (calculated as the net weight of hydrogen peroxide on the total weight of the composition);
c) one or more compounds according to formula II: 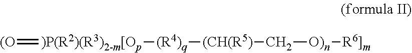
or a salt thereof,
wherein: R² is H or OH; R³ is OH; each R⁴ is independently an alkylene radical containing 1-18 carbon atoms and each R⁶ is independently H or an alkyl radical containing 1-18 carbon atoms, with the proviso that R⁴+R⁶≤20 total carbon atoms; each R⁵ is independently H or CH₃; m is 1 or 2; each n is independently 2-10; and each p and q is independently 0 or 1 with the proviso that when p is 0, q is 1,
and/or according to formula III: 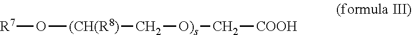
or a salt thereof,
wherein R⁷ is C(6-12)alkyl or C(6-12)alkenyl, R⁸ is H or CH₃, and s is 3-10,
in a total amount of from 0.1 to 10 wt. % (calculated on the total weight of the composition); and
wherein the disinfecting composition has a pH of from 0.5 to 3.5.

6. The disinfecting composition according to claim 1, wherein the disinfecting composition comprises the one or more compounds according to formula II, and wherein the one or more compounds according to formula II include a compound according to formula IIa: 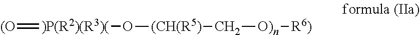
or a salt thereof,
wherein: R² is H or OH; R³ is OH; R⁵ is H or CH₃, n is 4-6; and R⁶ is an alkyl radical containing 4-18 carbon atoms.

7. The disinfecting composition according to claim 1, wherein the disinfecting composition has a pH of from 1.0 to 3.0.

8. The disinfecting composition according to claim 1, wherein the compound of formula I(a) is present in a total amount of from 0.2 to 10 wt. % (calculated on the total weight of the composition); and/or
wherein the hydrogen peroxide is present in an amount of from 0.2 to 7.0 wt. % (calculated on the net weight of hydrogen peroxide on the total weight of the composition); and/or
wherein the disinfecting composition comprises the one or more compounds according to formula II (a) in an amount of from 0.3 to 9.0 wt. % (calculated on the total weight of the composition).

9. The disinfecting composition according to claim 1, wherein the disinfecting composition further comprises a percarboxylic acid or a precursor thereof.

10. The disinfecting composition according to claim 1, wherein the disinfecting composition comprises less than 0.1 wt. % of an amine oxide surfactant according to the formula R¹⁰R¹¹R¹²N⁺O⁻, wherein R¹⁰ contains 8-18 carbon atoms and R¹¹ and R¹² each contain 1-4 carbon atoms (calculated on the total weight of the composition); and/or
wherein the disinfecting composition comprises less than 0.1 wt. % of a perhydrolase (calculated on the total weight of the composition).

11. The disinfecting composition according to claim 1, wherein the disinfecting composition comprises less than 3.0 wt. % of benzyl alcohol (calculated on the total weight of the composition).

12. The disinfecting composition according to claim 1, wherein the disinfecting composition is suitable for disinfecting a surface (suspected of being) infected with a bacterium, and/or a fungi, and/or a non-enveloped virus.

13. The disinfecting composition according to claim 1, wherein the disinfecting composition comprises a ((non-)ethoxylated) anionic surfactant in an amount of 0.2 to 5.0 wt. % (calculated on the total weight of the composition).

14. The disinfecting composition according to claim 1, wherein the disinfecting composition comprises:
a) the one or more compounds according to formula I, CH₃C(═O)OR¹, wherein R¹ is
C(1-5)alkoxy-C(2-3)alkyl wherein the C(1-5)alkoxy is optionally substituted with one hydroxyl group or methyl ester,
C(1-3)alkoxy-C(2-3)alkoxy-C(2-3)alkyl wherein the C(1-3)alkoxy is optionally substituted with one hydroxyl group or methyl ester,
C(2)alkyl substituted with one hydroxyl group or one methyl ester,
C(3-5)alkyl substituted with one hydroxyl group and one methyl ester,
C(3-5)alkyl substituted with one or two hydroxyl groups, or
C(3-5)alkyl substituted with one or two methyl esters,
in a total amount of from 1.0 to 10.0 wt. % (calculated on the total weight of the composition);
b) from 0.2 to 7.0 wt. % of hydrogen peroxide (calculated as the net weight of hydrogen peroxide on the total weight of the composition);
c) the one or more compounds according to formula II, (O═)P(R²)(R³)(—O—(CH(R⁵)—CH₂—O)ₙ—R⁶) or a salt thereof, wherein: R² is H or OH; R³ is OH; R⁵ is H or CH₃, n is 4-6; and R⁶ is an alkyl radical containing 4-18 carbon atoms, in a total amount of from 0.1 to 10 wt. % (as calculated on the total weight of the composition);
d) optionally, one or more anionic surfactants in a total amount of from 0.2 to 5.0 wt. % (calculated on the total weight of the composition),
e) from 0.01 to 2.0 wt. % of a hydrogen peroxide stabilizer (calculated on the total weight of the composition); and
f) one or more acids in a total amount of from 0.1 to 2.0 wt. % (calculated on the total weight of the composition); and
wherein the disinfecting composition has a pH of from 1.5 to 3.0, and
wherein the disinfecting composition comprises less than 3.0 wt. % of benzyl alcohol (calculated on the total weight of the composition).

15. The disinfecting composition according to claim 1, wherein the disinfecting composition comprises:
a) the one or more compounds according to formula I, CH₃C(═O)OR¹, wherein R¹ is
C(1-5)alkoxy-C(2-3)alkyl wherein the C(1-5)alkoxy is optionally substituted with one hydroxyl group or methyl ester,
C(1-3)alkoxy-C(2-3)alkoxy-C(2-3)alkyl wherein the C(1-3)alkoxy is optionally substituted with one hydroxyl group or methyl ester,
C(2)alkyl substituted with one hydroxyl group or one methyl ester,
C(3-5)alkyl substituted with one hydroxyl group and one methyl ester,
C(3-5)alkyl substituted with one or two hydroxyl groups, or
C(3-5)alkyl substituted with one or two methyl esters,
in a total amount of from 1.0 to 10.0 wt. % (calculated on the total weight of the composition);
b) from 0.2 to 7.0 wt. % of hydrogen peroxide (calculated as the net weight of hydrogen peroxide on the total weight of the composition);
c) the one or more compounds according to formula III, R⁷—O—(CH(R⁸)—CH₂—O)ₛ—CH₂—COOH or a salt thereof, wherein R⁷ is a C(6-12)alkyl or a C(6-12)alkenyl, R⁸ is H or CH₃, and s is 3-10, in a total amount of from 0.1 to 10 wt. % (as calculated on the total weight of the composition);
d) optionally, one or more anionic surfactants in a total amount of from 0.2 to 5.0 wt. % (calculated on the total weight of the composition),
e) from 0.01 to 2.0 wt. % of a hydrogen peroxide stabilizer (calculated on the total weight of the composition); and
f) one or more acids in a total amount of from 0.1 to 2.0 wt. % (calculated on the total weight of the composition); and
wherein the disinfecting composition has a pH of from 1.5 to 3.0,
wherein the disinfecting composition comprises less than 3.0 wt. % of benzyl alcohol (calculated on the total weight of the composition).

16. Towelette comprising the disinfecting composition according to claim 1.

17. Method of disinfecting a surface comprising applying the disinfecting composition according to claim 1 to the surface.

18. The method according to claim 17, wherein the surface comprises a material selected from the group of polyurethane (PU), poly(methyl metacrylate) (PMMA; Perspex), high-density polyethylene, low-density polyethylene, acrylonitrile butadiene styrene (ABS), acrylic polyvinyl chloride, polypropylene (PP), polycarbonate (PC), polyethylene terephthalate (PETG), aluminium, and stainless steel.
